(19) United States
(12) Patent Application Publication
(10) Pub. No.: US 2012/0191413 A1
(43) Pub. Date: Jul. 26, 2012

(54) SENSOR INFORMATION ANALYSIS SYSTEM AND ANALYSIS SERVER

(75) Inventors: Nobuo SATO, Saitama (JP); Satomi TSUJI, Koganei (JP); Kazuo YANO, Hino (JP); Miki HAYAKAWA, Fussa (JP)

(73) Assignee: HITACHI, LTD., Tokyo (JP)

(21) Appl. No.: 13/353,561

(22) Filed: Jan. 19, 2012

(30) Foreign Application Priority Data
Jan. 26, 2011 (JP) 2011-013694

(51) Int. Cl. G06F 15/00

(52) U.S. Cl. 702/176

(57) ABSTRACT

A desired number of a data transmitted from a sensor terminal of transmitting the data subjected to sensing within a predetermined time period is previously determined. An analysis server calculates an acquiring rate of a data used in a batch processing on the basis of the desired number of the data and a number of an effective data which is actually received from the plural sensor terminals within the previously determined time period. In a case where there is a variation in the acquiring rate of the data per unit time, the analysis server carries out the batch processing by using the data from the sensor terminal.

### CLAIM OF PRIORITY

The present application claims priority from Japanese patent application JP 2011-013694 filed on Jan. 26, 2011, the content of which is hereby incorporated by reference into this application.

### FIELD OF THE INVENTION

The present invention relates to a sensor information analysis system and an analysis server, and relates to a sensor information analysis system and an analysis server of analyzing a large amount of sensor data.

### BACKGROUND OF THE INVENTION

As a background art of the present field of the invention, there is a technology which is disclosed in, for example, Japanese Patent Application No. 2008-22896. According to the publication, an analysis is carried out by classifying the analysis to a time-triggered analysis and an event-triggered analysis by contents of the analysis. In the time-triggered analysis, there is carried out an analysis processing which becomes a basis necessary in carrying out visualization. Further, in the event-triggered analysis, a result of analysis which is calculated by the time-triggered analysis is processed and outputted by using a piece of information which is desired by a reader (refer to the abstract).

### SUMMARY

When a timing of transmitting sensor data from a sensor node does not stay constant, there is a case where the sensor data cannot be analyzed by a periodical batch processing. For example, in a case where the sensor node is not disposed at a prescribed location at a timing of transmitting the data by the sensor node, there is a case where the data cannot be acquired from the sensor node and cannot be reflected to the batch processing. In order to increase an accuracy of the contents, it is necessary to reflect an unprocessed data to the contents. When the batch processing is reexecuted, also data which have been processed in the past are also processed. Therefore, the processing becomes wasteful. Further, in a case where the batch processing is carried out after awaiting for collecting data from all of sensor nodes, the larger the number of the sensor nodes, the more increased the probability of being deficient in the data. Further, the larger the number of the sensor nodes, the more required the time period also in the batch processing. Therefore, time is taken until obtaining a result of the processing.

In view of the point described above, it is an object of the present invention to make a reduction in an amount of processing to analyze data and an increase in an accuracy of contents of a result of analysis compatible with each other.

In order to address the problem described above, for example, a configuration described in claims is adopted.

The present application includes plural specific means for resolving the problem described above included in a single inventive concept. When an example thereof is pointed out, the present application is featured in “an acquiring rate of a data used in a processing is held for each processing, and the batch processing is carried out only in a case where there is a variation in the data acquiring rate at each constant time period.

Further, the present application is featured in “even when sensing is not carried out, a data stating that sensing is not carried out is transmitted from a sensor terminal”.

For example, the acquiring rate of the data used in the processing is held for each processing, and the batch processing is carried out only in a case where there is a variation in the acquiring rate of the data at each constant time period. Further, even when there is brought about a state in which sensing is not carried out, a data stating that sensing is not carried out is transmitted from the sensor terminal. The batch processing may not be carried out when the variation in the acquiring rate exceeds a constant threshold. When the acquiring rate of the data exceeds the constant threshold, an analyzed state may be determined even when the acquiring rate is not 100%. Further, the processing described above is a processing for creating a display data.

According to one aspect of the present invention, there is provided a sensor information analysis system which includes plural sensor nodes of transmitting a data subjected to sensing, and an analysis server of carrying out a predetermined batch processing by using the data from plural sensor nodes, in which a desired number of the data transmitted from the sensor node within a previously determined time period is previously determined, the analysis server calculates a data acquiring rate on the basis of the desired number of the data, and a number of the data within the previously determined time period received actually from the plural sensor nodes with regard to the data used in the predetermined batch processing, and in a case where there is a variation in the data acquiring rate, the batch processing is carried out.

According to another aspect of the present invention, there is provided an analysis server which is an analysis server in a system which includes plural sensor nodes of transmitting a data subjected to sensing, and an analysis server of carrying out a predetermined batch processing by using the data from the plural sensor nodes, and in which a desired number of the data transmitted from the sensor node within a previously determined time period is previously determined, the analysis server calculates a data acquiring rate on the basis of the desired number of the data and a number of the data within the previously determined time period received actually from the plural sensor nodes with regard to the data used in the predetermined batch processing, and in a case where there is a variation in the data acquiring rate, the analysis server carries out the batch processing.

According to the aspects of the present invention, a reduction in a data analysis processing amount and an increase in an accuracy of contents of an analysis result can be made to be compatible with each other.

### BRIEF DESCRIPTION OF THE DRAWINGS

FIG. 1A shows Example (1) of a diagram configuring a sensor information processing analysis system;

FIG. 1B shows Example (2) of a diagram configuring a sensor information processing analysis system;

FIG. 1C shows Example (3) of a diagram configuring a sensor information processing analysis system;

FIG. 1D shows Example (4) of a diagram configuring a sensor information processing analysis system;

FIG. 1E shows Example (5) of a diagram configuring a sensor information processing analysis system;

FIG. 1F shows Example (6) of a diagram configuring a sensor information processing analysis system;

FIG. 1G shows Example (7) of a diagram configuring a sensor information processing analysis system;

FIG. 1H shows Example (8) of a diagram configuring a sensor information processing analysis system;

FIG. 2A shows Example (1) of a processing of a sensor information processing analysis system;

FIG. 2B shows Example (2) of a processing of a sensor information processing analysis system;

FIG. 2C shows Example (3) of a processing of a sensor information processing analysis system;

FIG. 2D shows Example (4) of a processing of a sensor information processing analysis system;

FIG. 3 shows an example of a user/location information table;

FIG. 4 shows an example of an individual processing reference table;

FIG. 5 shows an example of an individual processing time execution table;

FIG. 6 shows an example of a meeting table;

FIG. 7 shows an example of a body rhythm table;

FIG. 8 shows an example of an individual index table;

FIG. 9 shows an example of an organization information database;

FIG. 10 shows an example of a project table;

FIG. 11 shows an example of an organization processing reference table;

FIG. 12 shows an example of an organization processing time execution log table;

FIG. 13 shows an example of a meeting matrix;

FIG. 14 shows an example of an organization index;

FIG. 15 shows an example of project progress contents;

FIG. 16 shows an example of a network diagram;

FIG. 17 shows an example of a traveling expense database;

FIG. 18 shows an example of an individual business action master table;

FIG. 19 shows an example of an organization/project business action master table;

FIG. 20 shows an example of a meeting/body rhythm table after supplementary outputting;

FIG. 21 shows an example of a meeting matrix of respective users after supplementary outputting;

FIG. 22 shows an example of a network diagram of respective users after supplementary outputting;

FIG. 23 shows an example of a meeting matrix for respective teams after supplementary outputting;

FIG. 24 shows an example of a network diagram for respective teams after supplementary outputting;

FIG. 25 shows an example of a meeting/body rhythm table before a consistency processing; and

FIG. 26 shows an example of a meeting/body rhythm table after a consistency processing.

### DETAILED DESCRIPTION OF THE PREFERRED EMBODIMENTS

An explanation will be given of an embodiment of the present invention in reference to the drawings as follows.

First, an explanation will be given of a business microscope system in order to clarify positioning and function of an analysis system according to the embodiment. Here, a business microscope is a system for helping an organization to improve by observing an action or a behavior of a human being by a sensor node mounted to the human being, and illustrating a relationship between persons as an organization activity and an image of a current organization. Further, a data with regard to meeting detection and action and voice or the like which are acquired by a sensor node is generally referred to as organization dynamics data.

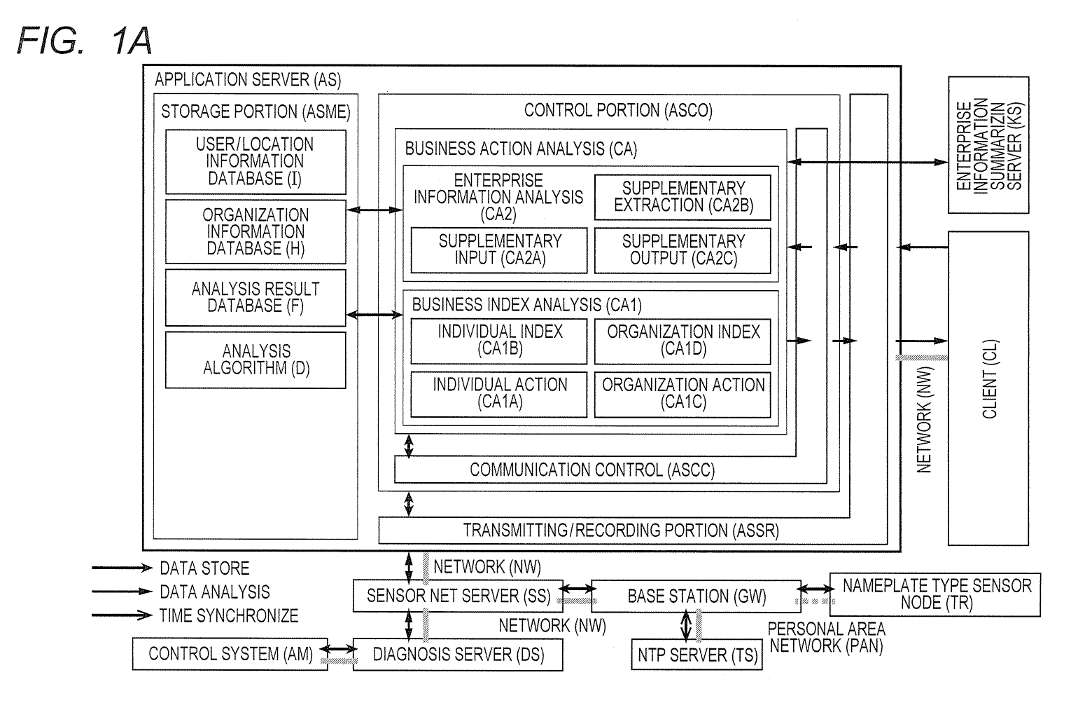

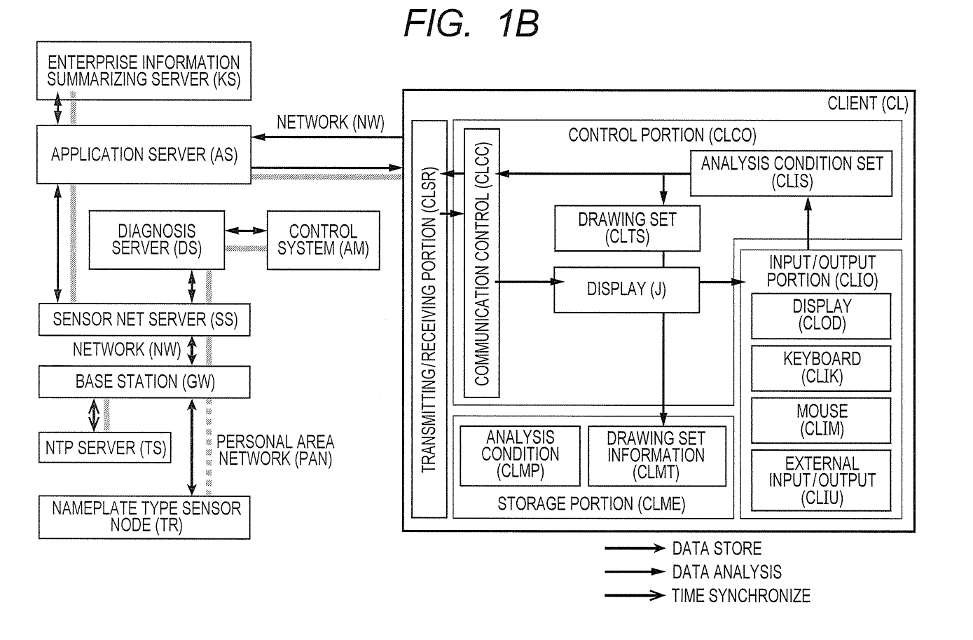

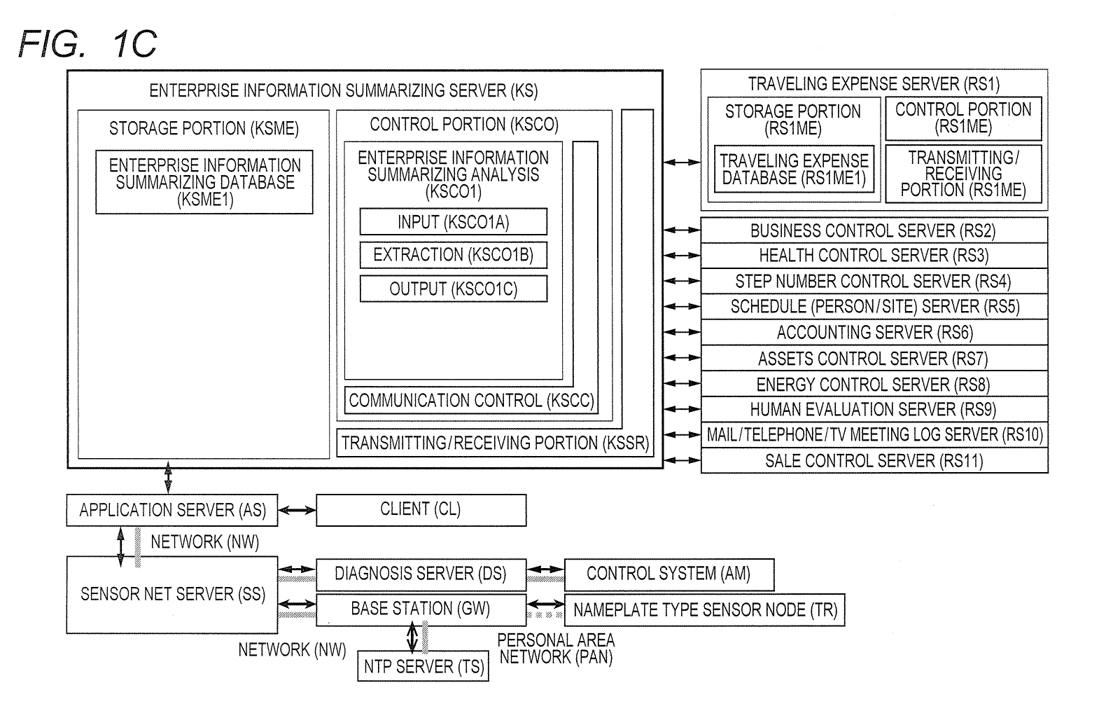

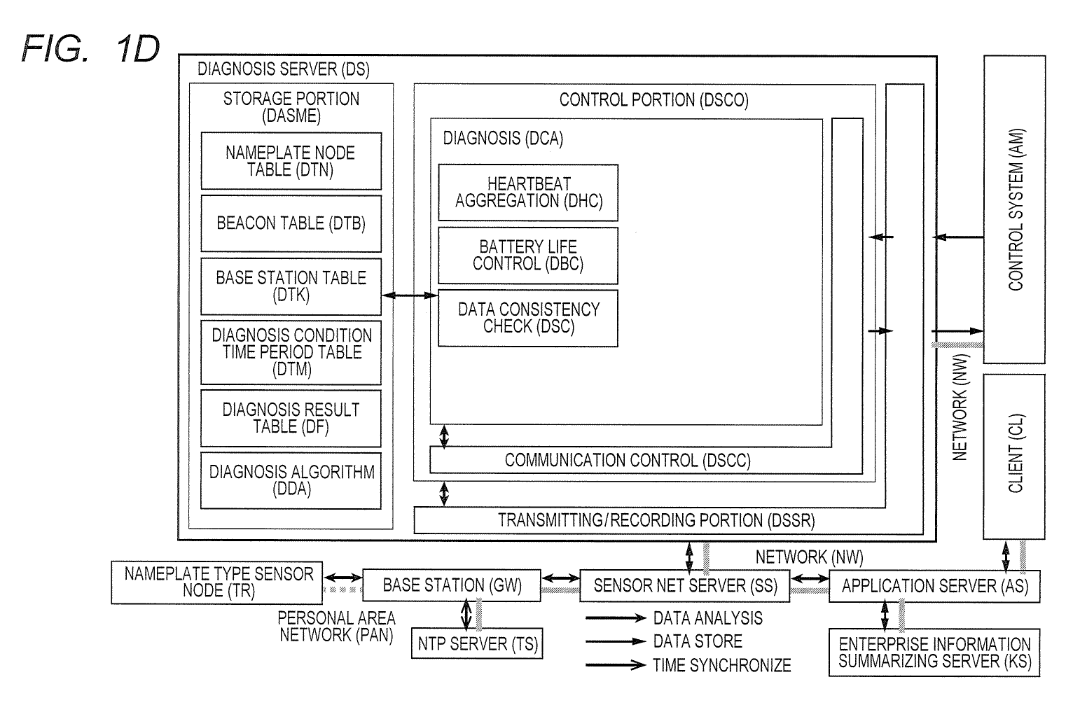

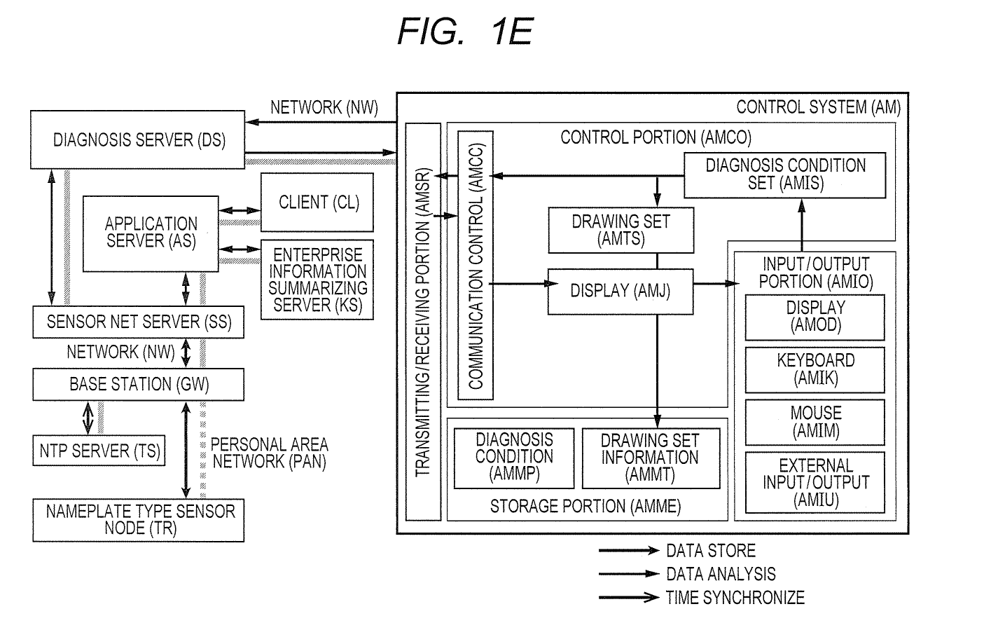

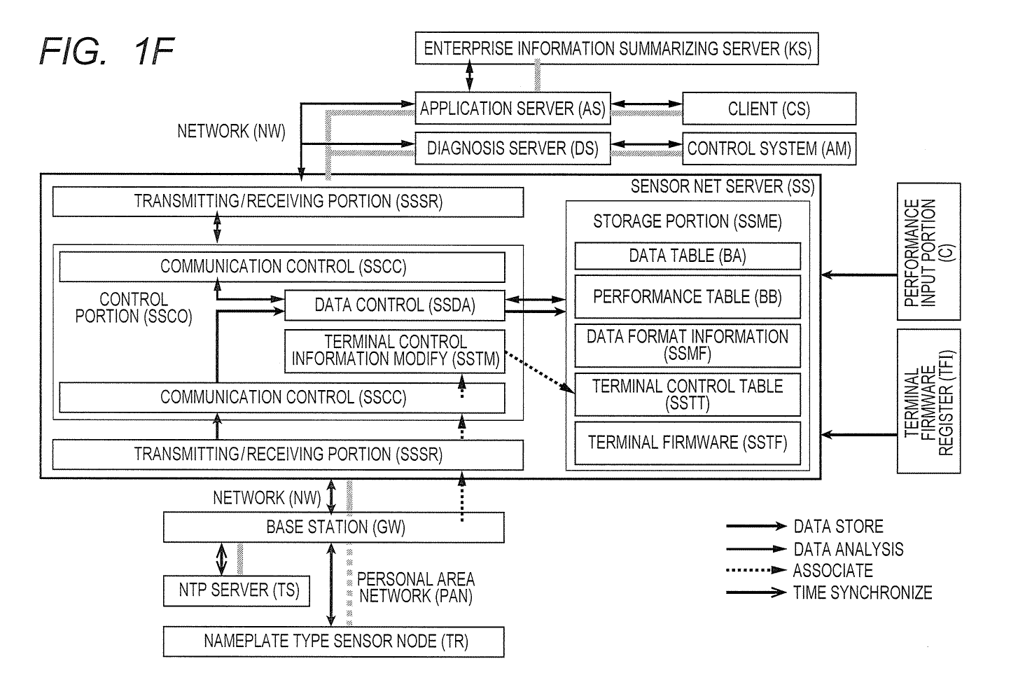

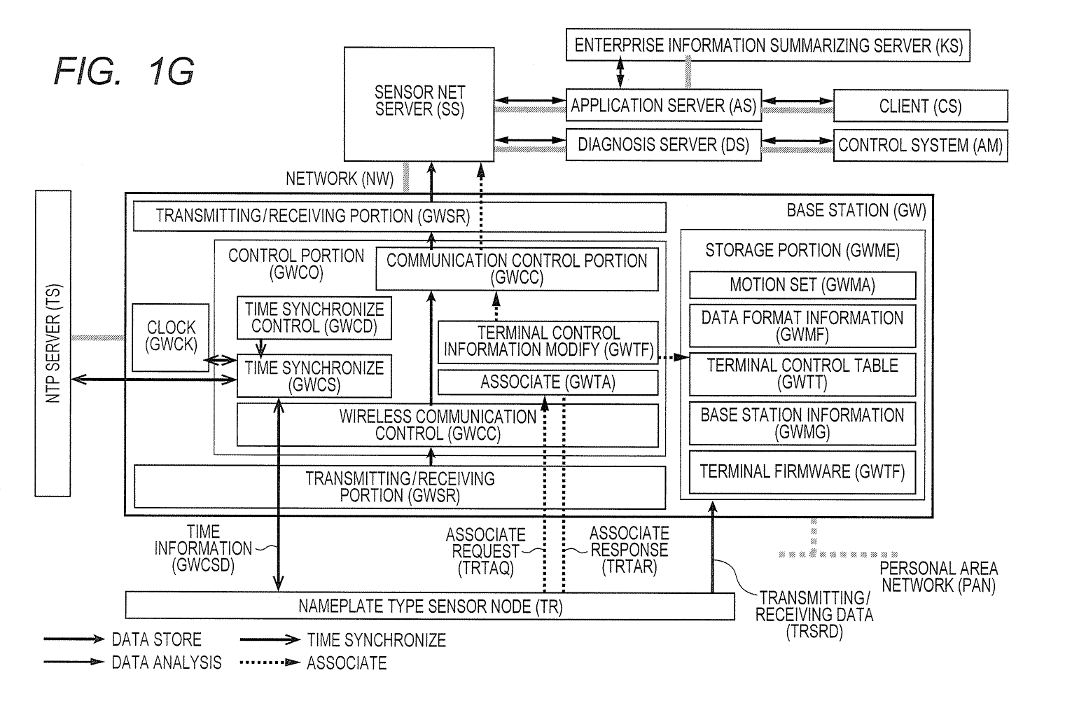

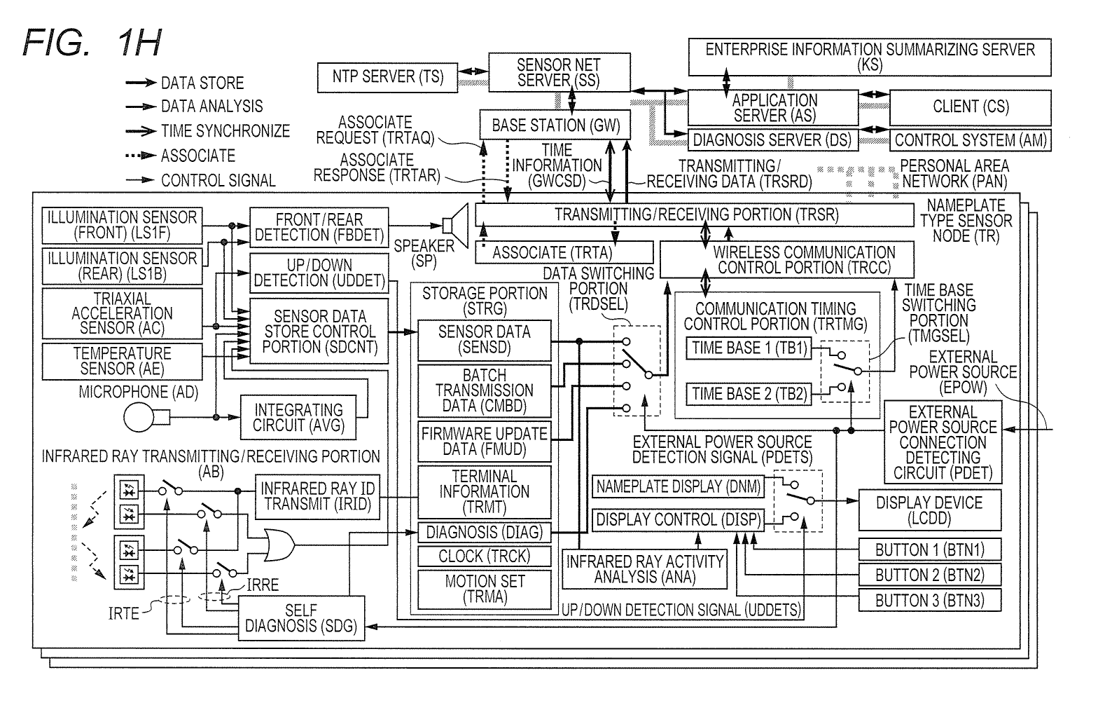

FIG. 1A, FIG. 1B, FIG. 1C, FIG. 1D FIG. 1E, FIG. 1F, FIG. 1G, and FIG. 1H are explanatory views showing constituent elements of a business microscope system according to an embodiment. Although these drawings are dividedly shown for convenience of illustration, respective processings which are illustrated respectively are executed in cooperation with each other.

FIGS. 1A, 1B, 1C, 1D, 1E, 1F, 1G, and 1H show a series of flows from Nameplate Type Sensor Node (TR) to Sensor Net Server (SS) of storing an organization dynamics data, Application Server (AS) of analyzing the organization dynamics data, and Client (CL) of outputting a result of analysis to a reader by way of Base Station (GW).

The present system includes Nameplate Type Sensor Node (TR), Base Station (GW), Sensor Net Server (SS), Application Server (AS), NTP Server (TS), Enterprise Information Summarizing Server (KS), Diagnosis Server (DS), Client (CL), and Control System (AM). Here, each of the nameplate type sensor node, the base station, various kinds of the servers, the client, and the control system includes an ordinary computer configuration including a central processing unit, a storage unit, and an network interface and the like.

Application Server (AS) shown in FIG. 1A analyzes and processes the organization dynamics data. Application Server (AS) starts an analysis application upon receiving a request from Client (CL) shown in FIG. 1B, or automatically and manually at set time.

The analysis application acquires the necessary organization dynamics data by requesting the data to Sensor Net Server (SS) shown in FIG. 1F. Further, the analysis application analyzes the acquired organization dynamics data, and returns a result of analysis to Client (CL) shown in FIG. 1B. Or, the analysis application may record the result of analysis to Analysis Result Database (F) as it is.

Enterprise Information Summarizing Server (KS) shown in FIG. 1C is a server of summarizing enterprise information in cooperation with other enterprise information system. Diagnosis Server (DS) shown in FIG. 1D carries out a diagnosis of whether a system is normally operated. A diagnosis application is started upon receiving a request from Control System (AM) shown in FIG. 1G, or automatically at set time. Control System (AM) shown in FIG. 1E is a point in contact with a system controller, and an interface of displaying a result of diagnosis of a system, and displaying and controlling a state of the system.

Further, an application which is used for an analysis is stored in Analyzing Algorithm (D), and is executed by Control Portion (ASCO). Processings which are executed in the present embodiment are Business Action Analysis (CA), Business Index Analysis (CA1), and Enterprise Information Analysis (CA2).

Application Server (AS) includes Transmitting/Receiving Portion (ASSR), Storage Portion (ASME), and Control Portion (ASCO).

Transmitting/Receiving Portion (ASSR) transmits and receives the organization dynamics data to and from Sensor Net Server (SS) shown in FIG. 1F, and Client (CL) shown in FIG. 1B. Specifically, Transmitting/Receiving Portion (ASSR) receives a command which is transmitted from Client (CL) and transmits a request for acquiring the organization dynamics data to Sensor Net Server (SS). Further, Transmitting/Receiving Portion (ASSR) receives the organization dynamics data from Sensor Net Server (SS), and transmits a result of analysis to Client (CL).

Storage Portion (ASME) is configured by an external recording device of a hard disk, a memory, or an SD card. Storage Portion (ASME) stores a set condition for an analysis and an analysis result. Specifically, Storage Portion (ASME) stores User/Location Information Database (I), Organization Information Database (H), and Analysis Algorithm (D).

User/Location Information Table (I) is a table which is described with individual information of a name, a professional position, a user ID and the like of a user, and information of a location.

Organization Information Database (H) is a database which is stored with a data which is necessary in modeling the organization of Productivity Index (HA), Accident/Failure Index (HB) or the like, and a data which is necessary in carrying out an organization activity such as weather, a stock price or the like as general information.

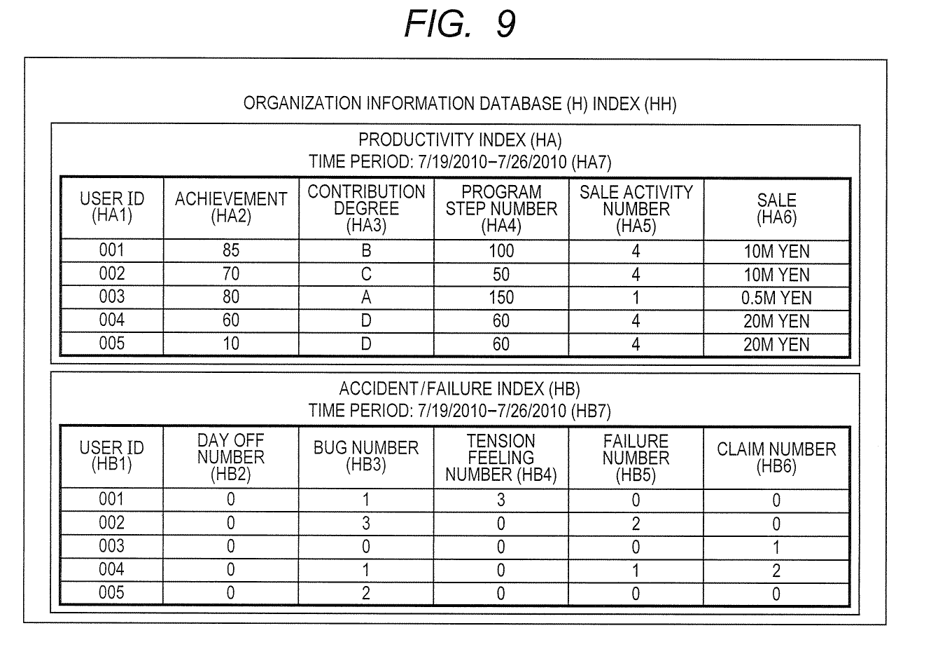

An explanation will be given of Organization Information Database (H) (refer to, for example, FIG. 9). Organization Information Table (HH) is stored with indexes with regard to an organization and a member. These are used in analyzing the organization.

Indexes with regard to a productivity are stored in Productivity Index (HA). The table is configured by User ID (HA1) of specifying a user and productivity indexes (Achievement (HA2), Contribution Degree (HA3), Program Step Number (HA4), Sale Activity Number (HA5), Sale (HAG)). A time period is Time Period: Jul. 19, 2010-Jul. 26, 2010 (HA7).

If an alphabetical expression is used as in Contribution Degree (HA3), the contribution degree is converted such that a good achievement becomes a large value. Further, in a case of an index for each team, a member belonging to the team substitutes the index for the same value. So far as the index is an index with regard to a productivity, the other index may be used.

Indexes with regard to an accident or a failure are stored in Accident/Failure Index (HB). The table is configured by User ID (HB1) of specifying a user and accident/failure indexes (Day Off Number (HB2), Bug Number (HB3), Tension Feeling Number (HB4), Failure Number (HB5), Claim Number (HB6)). A time period is Time Period: Jul. 19, 2010-Jul. 26, 2010 (HB7).

If the index is an index for each team, a member belonging to the team substitutes the index for the same value. Further, when the index is an index with regard to accident/failure, the other index may be used.

Analysis Result Database (F) is a database which is stored with a result of analyzing the organization dynamics data, or a result of (organization dynamics index).

Analysis Algorithm (D) is stored with a program which is used for an analysis. A pertinent program is selected in accordance with a request from Client (CL), and is transmitted to Control Portion (ASCO) and an analysis is executed.

Control Portion (ASCO) includes a central processing unit CPU (not illustrated), and executes a control of transmission/reception of a data and an analysis of a sensing data. Specifically, by executing a program which is stored in Storage Portion (ASME) by CPU (not illustrated), there are executed Communication Control (ASCC), Business Action Analysis (CA), Business Index Analysis (CA1), and Enterprise Information Analysis (CA2).

Communication Control (ASCC) controls a timing of a communication with Sensor Net Server (SS) and Client Data (CL) by wire or wireless. Further, Communication Control (ASCC) executes a conversion of a data format, and a distribution of a destination in accordance with a kind of a data.

Business Action Analysis (CA) is a processing of analyzing a business action. Business Action Analysis (CA) is configured by Business Analysis Index (CA1), and Enterprise Information Analysis (CA2).

Business Index Analysis (CA1) is a processing of calculating an individual index and an organization index in consideration of a rate of acquiring a sensor data. Individual Action (CA1) is a processing of extracting an individual action in consideration of the rate of acquiring the sensor data. Individual Index (CA1B) is a processing of extracting an individual index in consideration of the rate of acquiring the sensor data which is used in analyzing Individual Action (CA1A) by using Individual Action (CA1A). Organization Action (CA1C) is a processing of extracting an action which is carried out in an organization in consideration of the rate of acquiring the sensor data which is used in analyzing Individual Action (CA1A) by using Individual Action (CA1A). Organization Index (CA1D) is a processing of extracting an index of an organization in consideration of the rate of acquiring the sensor data which is used in analyzing Organization Action (CA1C) by using Organization Action (CA1C).

Enterprise Information Analysis (CA2) is a processing of supplementing Business Index Analysis (CA1) and providing information to Enterprise Information Summarizing Server (KS) in cooperation with Enterprise Information Summarizing Server (KS). Supplementary Input (CA2A) is a processing of reading a data of Enterprise Information Summarizing Database (KSME1) which is present in Enterprise Information Summarizing Server (KS) in order to supplement Business Index Analysis (CA1). Supplementary Extraction (CA2B) is a processing of supplementing Business Index Analysis (CA1) by using a data which is read by Supplementary Input (CA2A). Supplementary Output (CA2C) is a processing of outputting a result of Business Index Analysis (CA1).

A result of an analysis is transmitted to Analysis Result Database (F), or Display (J) of Client (CL) shown in FIG. 1B from Transmitting/Receiving Portion (ASSR).

Client (CL) shown in FIG. 1B is a point in contact with a user, and inputs/outputs a data. Client (CL) includes Input/Output Portion (CLIO), Transmitting/Receiving Portion (CLSR), Storage Portion (CLME), and Control Portion (CLCO).

Input/Output Portion (CLIO) is a portion which becomes an interface with a user. Input/Output Portion (CLIO) includes Display (CLOD), Keyboard (CLIK), Mouse (CLIM) and the like. Other input/output device can also be connected to External Input/Output (CLIU) as necessary.

Display (CLOD) is an image display device of CRT (CATHODE-RAY TUBE), a liquid crystal display or the like. Display (CLOD) may include a printer or the like.

Transmitting/Receiving Portion (CLSR) transmits and receives a data to and from Application Server (AS) shown in FIG. 1A or Sensor Net Server (SS) shown in FIG. 1F. Specifically, Transmitting/Receiving Portion (CLSR) transmits Analysis Condition (CLMP) to Application Server (AS) and receives a result of analysis.

Storage Portion (CLME) is configured by an external recording device of a hard disk, a memory or an SD card. Storage Portion (CLME) is recorded with information necessary for drawing of Analysis Condition (CLMP) and Drawing Set Information (CLMT) or the like. Analysis Condition (CLMP) is recorded with conditions of a number of members of an object of analysis, selection of an analyzing method or the like which are set from a user. Drawing Set Information (CLMT) is recorded with information with regard to a drawing position of what is plotted to which portion of a drawing. Further, Storage Portion (CLMT) may be stored with a program which is executed by CPU (not illustrated) of Control Portion (CLCO).

Control Portion (CLCO) includes CPU (not illustrated), and executes a control of a communication, an input of an analysis condition from Client User (US), and drawing for presenting a result of analysis to Client User (US) or the like. Specifically, CPU executes processings of Communication Control (CLCC), Analysis Condition Set (CLIS), Drawing Set (CLTS), and Display (J) by executing a program stored to Storage Portion (CLME).

Communication Control (CLCC) controls a timing of a communication to and from Application Server (AS), or Sensor Net Server (SS) by wire or wireless. Further, Communication Control (CLCC) converts a data format, and distributes a destination in accordance a kind of a data.

Analysis Condition Set (CLIS) receives an analysis condition designated from a user via Input/Output Portion (CLIO), and records the condition to Analysis Condition (CLMP) of Storage Portion (CLME). Here, there are set a time period of a data used for an analysis, a member, a kind of an analysis, and a parameter or the like for an analysis. Client (CL) requests the analysis by transmitting settings of these to Application Server (AS) and executes Drawing Set (CLTS) in parallel therewith.

Drawing Set (CLTS) calculates a method of displaying a result of analysis and a position of plotting the drawing on the basis of Analysis Condition (CLMP). A result of the processing is recorded to Drawing Set Information (CLMT) of Storage Portion (CLME).

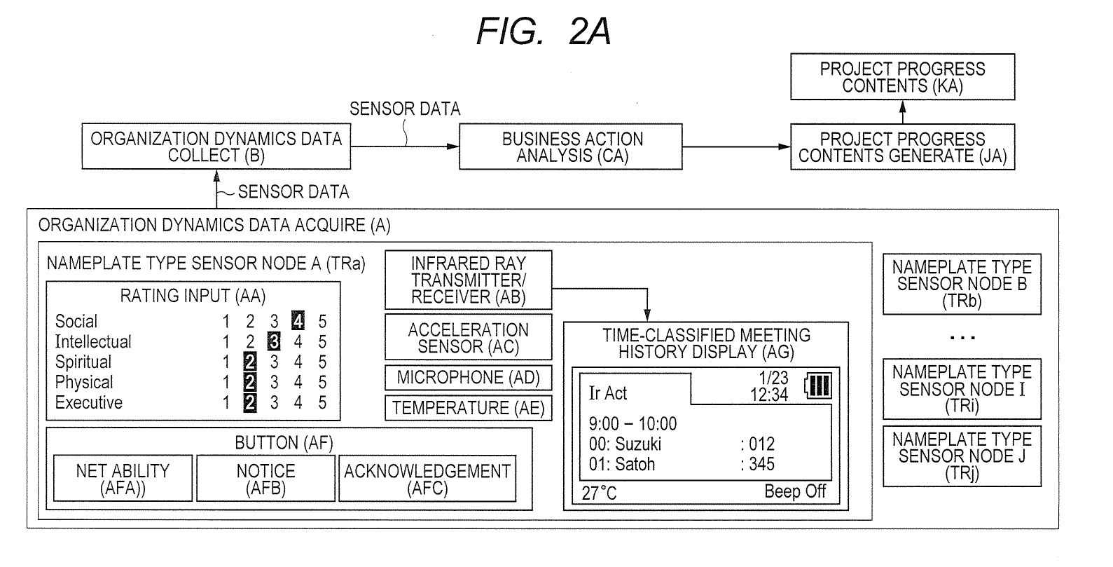

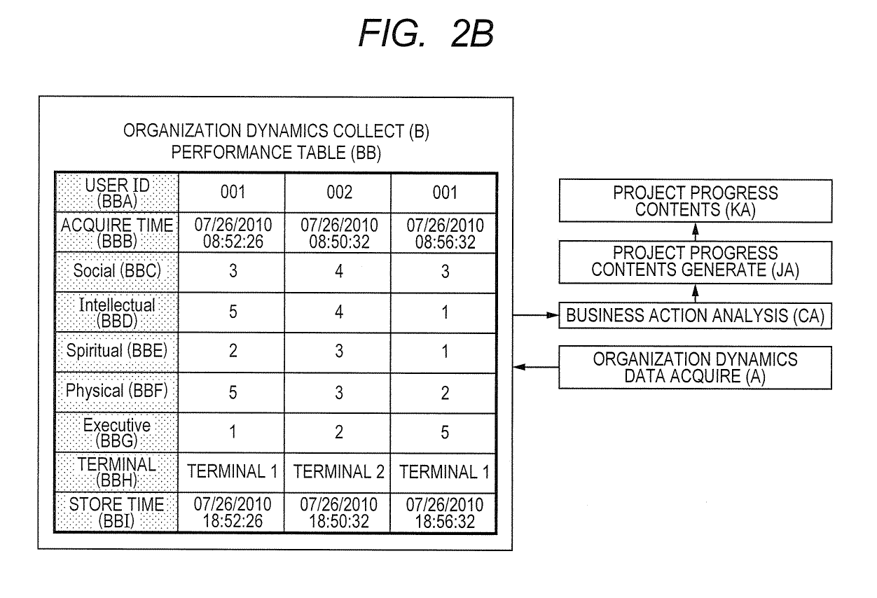

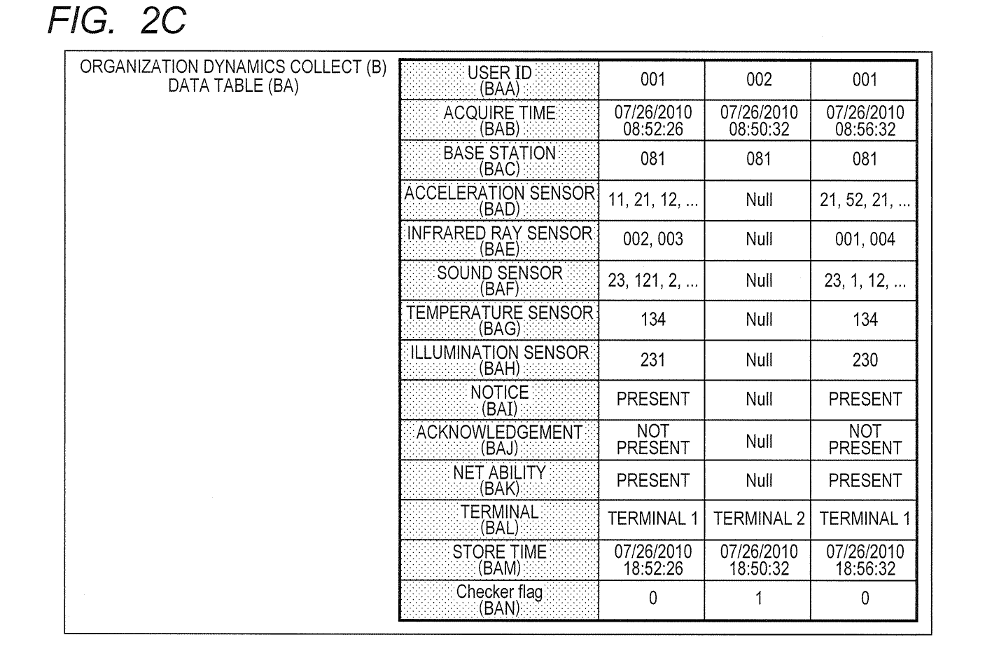

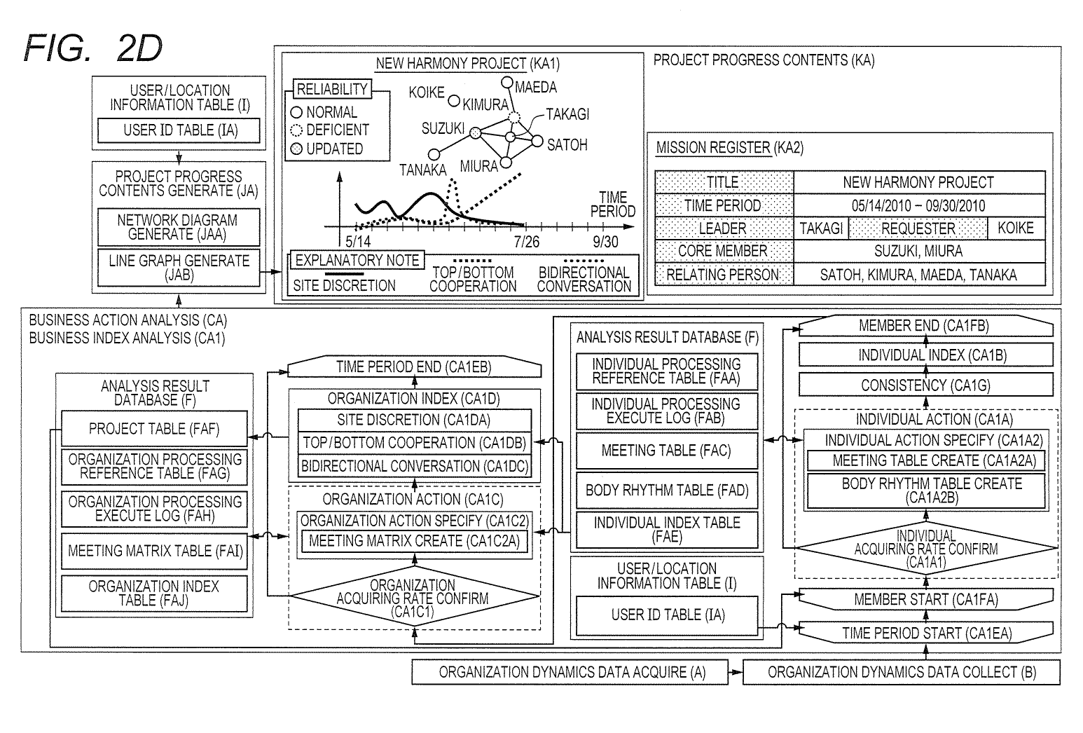

Display (J) generates a display of the result of analysis which is acquired from Application Server (AS) on the basis of a format which is described in Drawing Set Information (CLMT). For example, Drawing Set Information (CLMT) is stored with Model Drawing (JA) or the like. At this occasion, Display (J) displays also an attribute of a name of a person displayed or the like as necessary. A result of a display created is presented to a user via an output device of Display (CLOD) or the like. For example, Display (CLOD) displays a display of Project Progress Contents (KA) shown in FIG. 2D. A user can also finely adjust a display position by manipulation of drag & drop or the like.

Enterprise Information Summarizing Server (KS) shown in FIG. 1C summarizes enterprise information in cooperation with other enterprise information. Enterprise Information Summarizing Server (KS) includes Transmitting/Receiving portion (KSSR), Storage Portion (KSME), and Control Portion (KSCO).

Transmitting/Receiving Portion (KSSR) transmits and receives data to and from Application Server (AS) shown in FIG. 1A or Traveling Expense Server (RS1). Specifically, Transmitting/Receiving Portion (KSSR) transmits data of Enterprise Information Summarizing Database (KSME1) to Application Server (AS), or receives data of Traveling Expense Database (RS1ME1).

Storage Portion (KSME) is configured by an external recording device of a hard disk, a memory, or an SD card. Storage Portion (KSME) is recorded with information which is summarized with enterprise information which is referred to as Enterprise Information Summarizing Database (KSME1). Further, Storage Portion (KSME) may store a program which is executed by CPU (not illustrated) of Control Portion (KSCO).

Control Portion (KSCO) includes CPU (not illustrated) controls a communication, and controls Enterprise Information Summarizing Database (KSME1). Specifically, CPU executes a processing of Enterprise Information Analysis (KSCO1) by executing a program stored in Storage Portion (KSME).

Enterprise Information Summarizing Analysis (KSCO1) summarizes Enterprise Information Summarizing Database (KSME1), and provides information to other database in cooperation with other enterprise information summarizing server (for example, respective servers RS1 through RS11).

As an example of Enterprise Information Summarizing Database (KSME1), the database can be classified into two of individual and organization, and the classified databases are referred to as Individual Action Master Table (KSME1A) and Organization/Project Business Master Table (KSME1B).

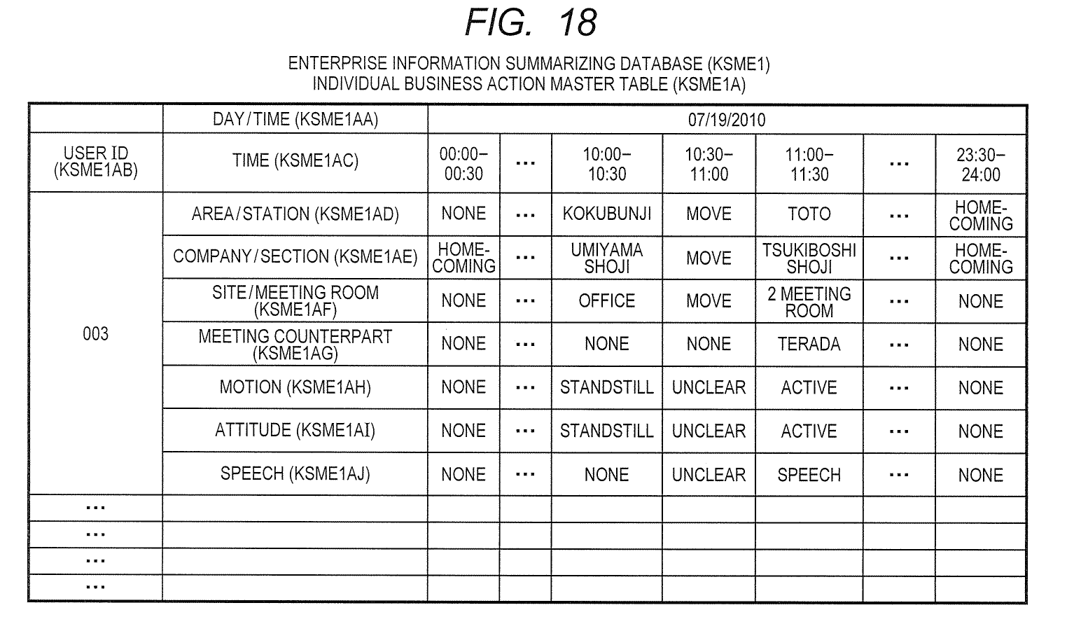

An explanation will be given of Individual Business Action Master Table (KSME1A). An example thereof is described in FIG. 18, where an action of one day of each user is recorded. Day/Time (KSME1AA) is recorded with day/time described. User ID (KSME1AB) is a unique ID indicating a member. Also User ID (IA1) of User/Location Information Database (I) will do. Time (KSME1AC) indicates start time and end time. Area/Station (KSME1AD) describes an area or a station at which a user is disposed at Time (KSME1AC). Company/Section (KSME1AE) describes a company or a section at which a user is disposed at Time (KSME1AC). Site/Meeting Room (KSME1AF) records a site or a meeting room at which a user is disposed at Time (KSME1AC). Meeting Counterpart (KSME1AG) describes a counterpart which a user meets at Time (KSME1AC). Plural counterparts can be described thereby. Motion (KSME1AH) describes a motion of a user at Time (KSME1AC). Attitude (KSME1AI) describes an attitude of a user at Time (KSME1AC). Speech (KSME1AJ) describes speech of a user at Time (KSME1AC).

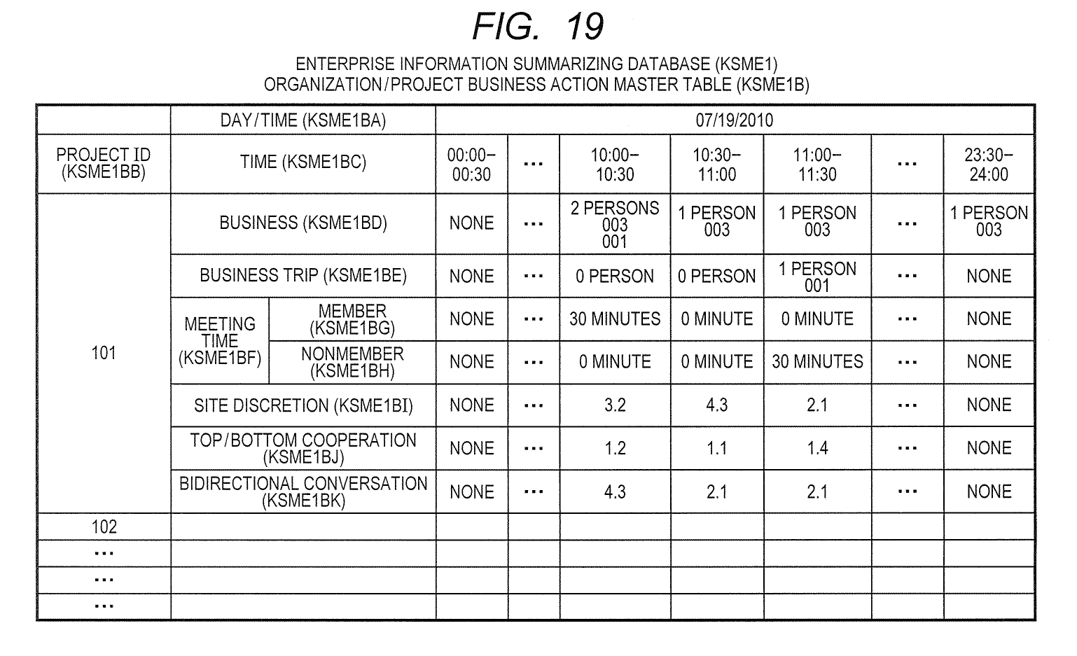

An explanation will be given of Organization/Business Action Master Table (KSME1B). An example thereof is described in FIG. 19, where an action of one day of each organization/object is recorded. Day/Time (KSME1BA) is recorded with day/time described. Project ID (KSME1BB) is a unique ID indicating organization/project. Mission ID (FAF1) at Project Table (FAF) of Analysis Result Database (F) will also do. Time (KSME1BC) indicates start time and end time. Business (KSME1BD) describes a member(s) who carries (carry) out a business (businesses) at Time (KSME1AC). Business Trip (KSME1BE) describes a member who makes a business trip at Time (KSME1AC). Meeting Time (KSME1BF) describes a member who carries out meeting at Time (KSME1AC), and meeting time. At that occasion, Meeting Time (KSME1BF) is classified to that of Member (KSME1BG) in a case of a meeting within members in the same organization/project, and Nonmember (KSME1BH) otherwise. Site Discretion (KSME1BI) is an index indicating a degree of discretion of a business at a site. Site Discretion (CA1DA) of Organization Index (CA1D) will also do. Top/Bottom Cooperation (KSME1BJ) is an index indicating a degree of cooperation from a managing staff to a member. Top/Cooperation (CA1DB) of Organization/Index (CA1D) will also do. Bidirectional Conversation (KSME1BK) is an index indicating a degree of a bidirectional behavior in meeting of members. Bidirectional Conversation (CA1DC) of Organization/Index (CA1D) will also do.

Further, it is an object of Enterprise Information Summarizing Database (KSME1) to summarize enterprise information. Therefore, when the object is satisfied, a table configuration of Enterprise Information Summarizing Database (KSME1) may differ from those of Individual Business Action Master Table (KSME1A) and Organization/Project Business Action Master Table (KSME1B).

Further, Business Information Summarizing Analysis (KSCO1) can supplementarily process respective tables of Analysis Result Database (F) by carrying out Enterprise Information Analysis (CA2) in Business Action Analysis (CA) of Application Server (AS).

As examples of databases, there are Traveling Expense Server (RS1), Business Control Server (RS2), Health Control Server (RS3), Step Number Control Server (RS4), Schedule (Person/Site) Server (RS5), Accounting Server (RS6), Assets Control Server (RS7), Energy Control Server (RS8), Human Evaluation Server (RS9), Mail/Telephone TV Meeting Log Server (RS10), Sale Control Server (RS11) and the like. Further, there may be carried out a cooperation with a server which includes business information other than the above-described.

Input (KSCO1A) is a processing of reading data of Traveling Expense Database (RS1ME1) of Traveling Expense Server (BS1) or the like. Extraction (KSCO1B) is a processing of supplementing Enterprise Information Summarizing Database (KSME1) by using data read by Input (KSCO1A). Output (KSCO1C) is a processing of outputting a result of Enterprise Information Summarizing Database (KSME1).

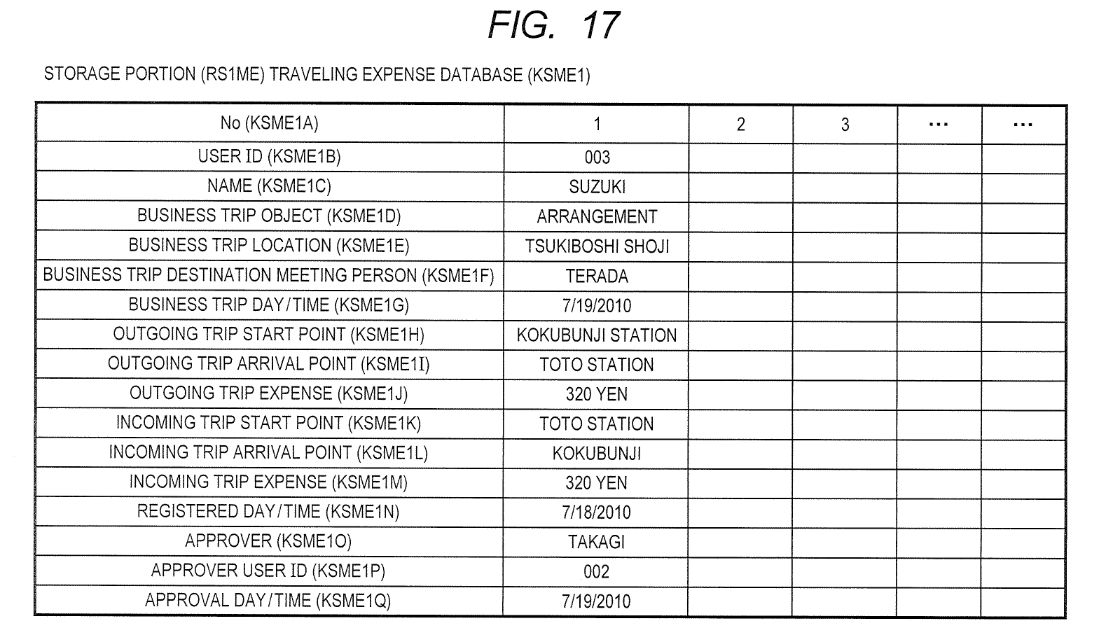

FIG. 17 shows an example of Traveling Expense Database (RS1ME1). This is a database which is registered when a user requests for a traveling expense. One column is added for each request of one time.

No (KSME1A) indicates a unique number of a request. User ID (KSME1B) is a unique ID showing a member. User ID (IA1) of User/Location Information Database (I) will also do. Name (KSME1C) is a name of a requesting person. Business Trip Object (KSME1D) is an object in the present business trip. Business Trip Location (KSME1E) is a location in the present business trip. Business Trip Destination Meeting Person (KSME1F) is a meeting person at the present business trip destination. Business Trip Day/Time (KSME1G) is day/time in the present business trip. Outgoing Trip Start Point (KSME1H) is a start point/station of outgoing trip in the present business trip. Outgoing Arrival Point (KSME1I) is an arrival point/station of an outgoing business trip in the present business trip. Outgoing Trip Expense (KSME1J) is an expense which is required for movement of the outgoing trip in the present business trip. Incoming Trip Start Point (KSME1K) is a start point/station of an incoming trip in the present business trip. Incoming Trip Arrival Point (KSME1L) is an arrival point/station of the incoming trip in the present business trip. Incoming Trip Expense (KSME1M) is an expense which is required for movement of the incoming trip in the present business trip. Registered Day/Time (SME1N) is day/time of the present registration. Approver (KSME1O) is a name of a person who approves the present business trip. Approver User ID (KSME1P) is a unique ID of the person who approves the present business trip. User ID (IA1) of User/Location Information Database (I) will also do. Approval Day/Time (KSME1Q) is time of approving the present business trip.

Further, it is an object of Traveling Expense Database (RS1ME1) to collect enterprise information. Therefore, a table configuration which is used in Traveling Expense Database (RS1ME1) may differ therefrom so far as the object is satisfied.

Further, a cooperation with outside may be used in an analysis in Business Action Analysis (CA) by using Traveling Expense Database (RS1ME1) via Enterprise Information Summarizing Server (KS).

Further, respective tables of Enterprise Information Summarizing Database (KSME1) can be supplementarily processed by Enterprise Information Summarizing Analysis (KSCO1).

Communication Control (CLCC) controls a timing of a communication with other server of Application Server (AS) or Traveling Expense Server (RS1) or the like by wire or wireless. Further, Communication Control (CLCC) converts a data format and distributes a destination in accordance with a kind of data.

Diagnosis Server (DS) shown in FIG. 1D diagnoses whether a system is normally operated. A diagnosis application is started upon receiving a request from Control System (AM) shown in FIG. 1E, or automatically at set time.

The diagnosis application acquires data from Sensor Net Server (SS), and determines whether there is a deficiency or an abnormality of data by Data Consistency Check (DHC). Further, the diagnosis application clarifies a nameplate type sensor node and a base station which do not carry out communications for a long period of time from information of heartbeat which is stored in Sensor Net Server (SS) and which is transmitted from the nameplate type sensor node and the base station by Heartbeat Aggregation (DHC). Battery Life Control (DBC) monitors battery life of a beacon which is stored in Sensor Net Server (SS).

A result of diagnosis may be displayed by Control System (AM), or stored in Diagnosis Result Database (DF).

Further, an application used in diagnosis is stored in Diagnosis Algorithm (DDA), and is executed by Control Portion (DSCO).

Diagnosis Server (DS) includes Transmitting/Receiving Portion (DSSR), Storage portion (DSME), and Control Portion (DSCO).

Transmitting/Receiving Portion (DSSR) transmits and receives a self diagnosis result of a system to and from Sensor Net Server (SS) shown in FIG. 1F and Control System (AM) shown in FIG. 1E. Specifically, Transmitting/Receiving Portion (DSSR) receives a command transmitted from Control System (AM) and transmits a request for acquiring an organization dynamics data to Sensor Net Server (SS). Further, Transmitting/Receiving Portion (DSSR) receives the organization dynamics data from Sensor Net Server (SS) and transmits a result of analysis to Control System (AM).

Storage Portion (DSME) is configured by an external recording device of a hard disk, a memory or an SD card. Storage Portion (DSME) stores a set condition for analysis and a result of analysis. Specifically, Storage Portion (DSME) stores Nameplate Node Table (DTN), Beacon Table (DTB), Base Station Table (DTK), Diagnosis Condition Time Period Table (DTM), Diagnosis Result Table (DF), and Diagnosis Algorithm (DDA).

Nameplate Node Table (DTN), Beacon Table (DTB), and Base Station Table (DTK) are tables which are described with information of a nameplate sensor node, a beacon, and a base station which become respective objects of diagnosis. Diagnosis condition time period table is a table which is stored with a condition and a time period of carrying out a diagnosis. Diagnosis Result Table (DF) is a table which is stored with a result of carrying out a diagnosis of a system.

Diagnosis Algorithm (DDA) is stored with a program which is used for a diagnosis. A pertinent program is selected and is transmitted to Control Portion (DSCO), and an analysis is executed in accordance with a request from Control System (AM).

Control Portion (DSCO) includes a central processing unit CPU (not illustrated), and executes a control of transmission/reception of data and an analysis of sensing data. Specifically, Communication Control (DSCC), Heartbeat Aggregation (DSC), Battery Life Control (DBC), and Data Consistency Check (DSC) are executed by executing a program stored in Storage Portion (DSME) by CPU (not illustrated).

Communication Control (DSCC) controls a timing of a communication with Sensor Net Server (SS) and Control System (AM) by wire or wireless. Further, Communication Control (DSCC) executes a data format conversion and a distribution of a destination in accordance with a kind of data.

A result of diagnosis is stored to Diagnosis Result Table (DF), or transmitted from Transmitting/Receiving Portion (DSSR) to Display (AMJ) of Control System (AM) shown in FIG. 1E.

Control System (AM) shown in FIG. 1E is a point in contact with a system controller, and an interface of displaying a result of diagnosis of a system, and displaying and controlling a state of the system. Control System (AM) includes Input/Output Portion (AMIO), Transmitting/Receiving Portion (AMSR), Storage Portion (AMME), and Control Portion (AMCO).

Input/Output Portion (AMIO) is a portion which becomes an interface with a system controller. Input/Output Portion (AMIO) includes Display (AMOD), Keyboard (AMIK), and Mouse (AMIM) and the like. Other input/output device can also be connected to External Input/Output (AMIU) as necessary.

Display (AMOD) is an image display device of CRT (CATHODE-RAY TUBE), a liquid crystal display or the like. Display (AMOD) may include a printer or the like.

Transmitting/Receiving Portion (AMSR) transmits and receives data to and from Diagnosis Server (DS) shown in FIG. 1D or Sensor Net Server (SS) shown in FIG. 1F. Specifically, Transmitting/Receiving Portion (AMSR) transmits Diagnosis Condition (AMMP) to Diagnosis Server (DS) and receives a result of diagnosis.

Storage Portion (AMME) is configured by an external recording device of a hard disk, a memory or an SD card. Storage Portion (AMME) records information necessary for drawing of Diagnosis Condition (AMMP) and Drawing Set Information (AMMT). Diagnosis Condition (AMMP) records conditions of a number of members of diagnosis objects set by a user as well as selection of an analysis method or the like. Drawing Set Information (AMMT) records information with regard to a drawing position of what is plotted to which portion of a drawing. Further, Storage Portion (AMME) may store a program which is executed by CPU (not illustrated) of Control Portion (AMCO).

Control Portion (AMCO) includes CPU (not illustrated), and executes a control of a communication, an input of an analysis condition from a system controller, and drawing for presenting a diagnosis result to a system controller. Specifically, CPU executes processings of Communication Control (AMCC), Diagnosis Condition Set (AMIS), Drawing Set (AMTS), and Display (AMJ) by executing a program which is stored in Storage Portion (ANNE).

Communication Control (AMCC) controls a timing of a communication to and from Diagnosis Server (DS) or Sensor Net Server (SS) by wire or wireless. Communication Control (AMCC) converts a data format and distributes a destination in accordance with a kind of data.

Diagnosis Condition Set (AMIS) receives an analysis condition which is designated from a user by way of Input/Output Portion (AMIO), and records the analysis condition to Diagnosis Condition (AMMP) of Storage Portion (AMME). Here, there are a time period of data used for diagnosis, members, a kind of diagnosis and a parameter for diagnosis and the like. Control System (AM) transmits setting of these to Diagnosis Server (DS), requests an analysis thereof, and executes Drawing Set (AMTS) in parallel therewith.

Drawing Set (AMTS) calculates a method of displaying an analysis result based on Diagnosis Condition (AMMP), and a position of plotting a drawing. A result of the processing is recorded to Drawing Set Information (AMMT) of Storage Portion (AMME).

Display (AMJ) generates a display on the basis of a format of describing the analysis result which is acquired from Diagnosis Server (DS) at Drawing Set Information (AMMT).

Sensor Net Server (SS) shown in FIG. 1F controls data gathered from Nameplate Type Sensor Node (TR) shown in FIG. 1H. Specifically, Sensor Net Server (SS) stores data transmitted from Base Station (GW) shown in FIG. 1G to a database, and transmits sensing data on the basis of requests from Application Server (AS) shown in FIG. 1A, and Client (CL) shown in FIG. 1B. Further, Sensor Net Server (SS) receives a control command from Base Station (GW) and returns a result which is obtained from the control command to Base Station (GW).

Sensor Net Server (SS) includes Transmitting/Receiving Portion (SSSR), Storage Portion (SSME), and Control Portion (SSCO). In a case where Time Synchronize Control (GWCD) is executed at Sensor Net Server (SS), Sensor Net Server (SS) also needs a clock.

Transmitting/Receiving Portion (SSSR) transmits and receives data to and from Base Station (GW), Application Server (AS), and Client (CL). Specifically, Transmitting/Receiving Portion (SSSR) receives sensing data transmitted from Base station (GW), and transmits sensing data to Application Server (AS), or Client (CL).

Storage Portion (SSME) is configured by a nonvolatile storage device of a hard disk, a flash memory or the like, and stores at least Data Table (BA), Performance Table (BB), Data Format Information (SSMF), Terminal Control Table (SSTT), and Terminal Firmware (SSTF). Further, Storage Portion (SSME) may store a program which is executed by CPU (not illustrated) of Control Portion (SSCO).

Data Table (BA) is a database for recording organization dynamics data acquired by Nameplate Type Sensor Node (TR), information of Nameplate Type Sensor Node (TR), and information of Base Station (GW) through which organization dynamics data transmitted from Nameplate Type Sensor Node (TR) passes or the like. A column is created for each element of data of acceleration, temperature or the like, and data is controlled. Further, a table may be created for each element of data. In either of cases, all of data are stored to Organization Dynamics Data Collect (B) in relation to Terminal Information (TRMT) which is an ID of Nameplate Type Sensor Node (TR) acquired, and information with regard to acquired time.

Performance Table (BB) is a database for recording evaluation (performance) with regard to an organization or an individual which is inputted from Nameplate Type Sensor Node (TR) or existing data along with time data.

Data Format Information (SSMF) is recorded with a data format for communication, a method of cutting to divide sensing data which is tagged by Base Station (GW) to record to a database, and a method of dealing with a request for data or the like. As explained later, after receiving data and before transmitting data, Data Format Information (SSMF) is necessarily referred to by Communication Control Portion (SSCC), and Data Format Information (SSMF) and Data Control (SSDA) are carried out.

Terminal Control Table (SSTT) is a table of recording which Nameplate Type Sensor Node (TR) is currently under control of which Base Station (GW). In a case where Nameplate Type Sensor Node (TR) is added newly under control of Base Station (GW), Terminal Control Table (SSTT) is updated.

Terminal Firmware (SSTF) temporarily stores Terminal Firmware (GWTF) updated of a nameplate type sensor node which is stored in Terminal Firmware Register Portion (TFI).

Control Portion (SSCO) includes a central processing unit CPU (not illustrated), and controls transmission/reception of sensing data and recording and outputting sensing data to and from a database. Specifically, by executing a program stored to Storage Portion (SSME) by CPU, there are executed processings of Communication Control (SSCC), Terminal Control Information Modify (SSTM), and Data Control (SSDA) or the like.

Communication Control Portion (SSCC) controls a timing of a communication with Base Station (GW), Application Server (AS) and Client (CL) by wire or wireless. Further, as described above, Communication Control Portion (SSCC) converts a format of transmitted/received data to a data format in Sensor Net Server (SS), or a data format which is specified to each communication counterpart on the basis of Data Format Information (SSMF) which is recorded in Storage Portion (SSME). Further, Communication Control (SSCC) reads a header portion indicating a kind of data, and distributes data to corresponding processing portion. Specifically, received data is distributed to Data Control (SSDA), and a command of modifying terminal control information is distributed to Terminal Control Information Modify (SSTM). A destination of transmitted data is determined by Base Station (GW), Application Server (AS), or Client (CL).

Terminal Control Information Modify (SSTM) updates Terminal Control Table (SSTT) in receiving a command of modifying terminal control information from Base Station (GW).

Data Control (SSDA) controls modification, acquisition, and addition of data in Storage Portion (SSME). For example, by Data Control (SSDA), sensing data is recorded to a pertinent column of a database for respective elements of data based on tag information. Also in reading sensing data from a database, there is carried out a processing of selecting necessary data on the basis of time information and terminal information, and rearranging data in an order of time.

Performance Input (C) is a processing of inputting a value indicating performance. Here, performance is a subjective or objective evaluation which is determined on the basis of some reference. For example, a person who is mounted with Nameplate Type Sensor Node (TR) inputs a value of a subjective evaluation (performance) on the basis of some reference of a degree of fulfilling a task, a degree of contributing to an organization, and a degree of satisfaction or the like at the time point at a prescribed timing. The prescribed timing may be, for example, once per several hours, once per one day, or a time point at which an event of a meeting or the like has been finished. A person who is mounted with Nameplate Type Sensor Node (TR) can input a value of a performance by manipulating Nameplate Type Sensor Node (TR), or manipulating a personal computer (PC) of Client (CL) or the like. Or, the person may input a value which is described by handwriting summarizingly to PC after a while. In the present embodiment, there is shown an example of capable of inputting performances of person (SOCIAL), act (INTELLECTUAL), heart (SPIRITUAL), body (PHYSICAL), and knowledge (EXECUTIVE) by a nameplate type sensor node as ratings. The inputted performance values are used in an analysis processing. Respective questions signify “A fertile human relationship (cooperation and common feeling) can be created?” for person, “What is to be done can be executed?” for act, “A sense of accomplishment and a sense of fulfillment have been felt in a task?” for heart, “A consideration (rest and nutrition and exercise) could be given to the body?” for body, and “New intellectual experience (notice, knowledge) could be obtained?” for knowledge.

A performance with regard to an organization may be calculated from a performance of an individual. Objective data of sale, cost or the like, and data which has already been converted into a numerical value of a result of a questionnaire to customers or the like may periodically be inputted as performances. In a case where a numerical value is obtained automatically as in an error occurrence rate in production control or the like, the obtained numerical value may automatically be inputted as a value of a performance. Further, an economic index of gross national product (GNP) or the like may be inputted. These are stored in Organization Information Table (H).

Base Station (GW) shown in FIG. 1G has a role of intermediating Nameplate Type Sensor Node (TR) shown in FIG. 1H and Sensor Net Server (SS) shown in FIG. 1F. Plural Base Stations (GW) are arranged to cover regions of a living quarter, a work place and the like in consideration of a wireless reaching distance. Base Station (GW) includes Transmitting/Receiving Portion (GWSR), Storage Portion (GWME), Clock (GWCK) and Control Portion (GWCO).

Transmitting/Receiving Portion (GWSR) receives wireless from Nameplate Type Sensor Node (TR) and carries out a transmission by wire or wireless to Base Station (GW). Further, Transmitting/Receiving Portion (GWSR) includes an antenna for receiving wireless.

Storage Portion (GWME) is configured by a nonvolatile storage device of a hard disk, or a flash memory. Storage Portion (GWME) is stored with at least Motion Set (GWMA), Data Format Information (GWMF), Terminal Control Table (GWTT), and Base Station Information (GWMG). Motion Set (GWMA) includes a piece of information indicating an operating method of Base Station (GW). Data Format Information (GWMF) includes apiece of information indicating a data format for communication, and a piece of information which is necessary for attaching a tag to sensing data. Terminal Control Table (GWTT) includes Terminal Information (TRMT) of Nameplate Type Sensor Node (TR) under control thereof which can be associated with currently, and a local ID which is distributed for controlling Nameplate Type Sensor Node's (TR). Base Station Information (GWMG) includes a piece of information of an address or the like of Base Station (GW) per se. Further, Storage Portion (GWME) is temporarily stored with updated Terminal Firmware (GWTF) of a nameplate type sensor node.

Storage Portion (GWME) may further be stored with a program which is executed by a central processing unit CPU (not illustrated) in Control Portion (GWCO).

Clock (GWCK) holds time information. The time information is updated at constant intervals. Specifically, time information of Clock (GWCK) is corrected by time information which is acquired from NTP (NETWORK TIME PROTOCOL) Server (TS) at constant intervals.

Control Portion (GWCO) includes CPU (not illustrated). By executing a program stored in Storage Portion (GWME) by CPU, there are controlled a timing of acquiring sensing data sensor information, a timing of processing sensing data, a timing of transmission/reception to and from Nameplate Type Sensor Node (TR) or Sensor Net Server (SS), as well as a timing of time synchronization. Specifically, by executing a program stored to Storage Portion (GWME) by CPU, there are executed processings of Communication Control Portion (GWCC), Associate (GWTA), Time Synchronize Control (GWCD), and Time Synchronize (GWCS) or the like.

Communication Control Portion (GWCC) controls timings of communication with Nameplate Type Sensor Node (TR) and Sensor Net Server (SS) by wireless or wire. Further, Communication Control Portion (GWCC) distinguishes a kind of data received. Specifically, Communication Control Portion (GWCC) identifies whether received data is general sensing data, data for association, a response of time synchronization or the like from a header portion of data, and theses data are conveyed to respective pertinent functions.

Further, Communication Control Portion (GWCC) executes Data Format Convert (GWMF) of converting data in a format pertinent for transmission/reception and adding tag information for indicating a kind of data in reference to Data Format Information (GWMF) recorded to Storage Portion (GWME).

Associate (GWTA) transmits Response (TRTAR) to Associate Request (TRTAQ) transmitted from Nameplate Type Sensor Node (TR), and transmits a local ID assigned to Nameplate Type Sensor Node (TR). When association is established, Associate (GWTA) modifies terminal control information by using Terminal Control Table (GWTT) and Terminal Firmware (GWTF).

Time Synchronize Control (GWCD) controls an interval and a timing of executing time synchronization, and issues an instruction so as to synchronize time. Or, an instruction may generally be transmitted from Sensor Net Server (SS) to Base Station (GW) of a total of a system by executing Time Synchronize (GWCS) by Sensor Net Server (SS) which will be explained later.

Time Synchronize (GWCS) requests and acquires time information by being connected to NTP Server (TS) on a network. Time Synchronize (GWCS) corrects Clock (GWCK) on the basis of acquired time information. Further, Time Synchronize (GWCS) transmits an instruction of time synchronization and Time Information (GWCSD) to Nameplate Type Sensor Node (TR).

FIG. 1H shows a function configuration of Nameplate Type Sensor Node (TR) which is an embodiment of a sensor node. Nameplate Type Sensor Node (TR) is mounted with plural Infrared Ray Transmitting/Receiving Portions (AB) for detecting a meeting situation of a human being, Triaxial Acceleration Sensor (AC) for detecting a motion of a person who wears Nameplate Type Sensor Node (TR), Microphone (AD) for detecting speech of a wearing person and surrounding sound, and various sensors of illumination Sensors (LS1F, LS1B) for detecting front/rear of the nameplate type sensor node, Temperature Sensor (AE). The sensor to be mounted is an example, and other sensor may be used for detecting a meeting situation and a motion of a wearing person.

It is a feature of the nameplate type sensor node of the business microscope that plural infrared ray transmitting/receiving circuits are mounted in order to firmly acquire a meeting situation even in what positional relationship a person and a person meet together. In the drawing, two sets of infrared ray transmitting/receiving portions are described. Infrared Ray Transmitting/Receiving Portion (AB) continues transmitting Terminal Information (TRMT) which is inherent identifying information of Nameplate Type Sensor Node (TR) periodically in a front direction. In a case where a person who is mounted with other Nameplate Type Sensor Node (TR) is disposed substantially in a front direction (for example, a front direction or a skewed front direction), Nameplate Type Sensor Node (TR) and other Nameplate Type Sensor Node (TR) exchange respective pieces of Terminal Information (TRMT) to each other by infrared rays. Thereby, it can be recorded who meets whom.

Each infrared ray transmitting/receiving portion is generally configured by a module which is combined with an infrared ray emitting diode for transmitting an infrared ray, and an infrared ray phototransistor. Infrared Ray ID Transmitting Portion (IRID) generates Terminal Information (TRMT) which is an ID of its own and transfers Terminal Information (TRMT) to an infrared ray emitting diode of an infrared ray transmitting/receiving module. In the present embodiment, in transmitting data, all of infrared ray emitting diodes are simultaneously lighted by transmitting the same data to plural infrared ray transmitting/receiving modules. Naturally, other data may be outputted at timings respectively independent from each other.

Further, a logical sum is calculated by Logical Sum Circuit (IROR) for data received by an infrared ray phototransistor of Infrared Ray Transmitting/Receiving Portion (AB). That is, when an ID is received by any one of infrared ray receiving portions at minimum, the ID is recognized by a nameplate type sensor node. Naturally, there may be configured plural independent circuits of receiving an ID. In this case, there can be grasped transmitting/receiving states for respective infrared ray transmitting/receiving modules. Therefore, for example, there can also be acquired additional information of in what direction meeting other nameplate type sensor node is directed.

Further, Self Diagnosis Portion (SDG) carries out a self diagnosis by detecting that a nameplate type sensor node is mounted to, for example, Cradle (CRD). Self Diagnosis Portion (SDG) has a mechanism of capable of individually controlling ON/OFF's of respective infrared ray modules by generating Transmission Enable Signal (IRTE) and Reception Enable Signal (IRRE) by a previously set sequence in order to detect a failure by loop back by plural infrared rays as described later in details. In the present embodiment, a function diagnosis by loop back can be carried out while minimizing an interference between a transmitting circuit and a receiving circuit by receiving data which is transmitted by a transmitting circuit of one infrared ray transmitter/receiver module by a receiving circuit of other infrared transmitter/receiving module.

Sensor Data (SENSD) detected by a sensor is stored to Storage Portion (STRG) by Sensor Data Store Control Portion (SDCNT). Sensor Data (SENSD) is processed into a transmission packet by Communication Control Portion (TRCC) and is transmitted to Base Station (GW) by Transmitting/Receiving portion (TRSR).

At this occasion, it is Communication Timing Control Portion (TRGMG) which outputs Sensor Data (SENSD) from Storage Portion (STRG) and generates a timing of carrying out wireless transmission. Communication Timing Control Portion (TRTMG) has plural time bases of generating plural timings.

As data stored to Storage Portion (STRG), there are Sensor Data (SENSD) detected by a sensor currently as well as Batch Transmission Data (CMBD) which is accumulated in the past, Firmware Update Data (FMUD) for updating a firmware which is an operating program of a nameplate type sensor node and the like.

Nameplate Type Sensor Node (TR) of the present embodiment detects that External Power Source (EPOW) is connected by External Power Source Connection Detecting Circuit (PDET), and generates External Power Source Detection Signal (PDETS). A configuration particular to the present embodiment is configured by Time Base Switching Portion (TMGSEL) of switching a transmission timing which is generated by Communication Timing Control Portion (TRTMG), or Data Switching Portion (TRDSEL) of switching data which is subjected to wireless communication. FIG. 1H illustrates, as an example, a configuration in which as a transmission timing, Time Base Switching Portion (TMGSEL) switches two time basis of two time bases of Time Base 1 (TB1) and Time Base 2 (TB2) by External Power Source Detecting Signal (PDETS). Further, FIG. 1H illustrates a configuration in which Data Switching Portion (TRDSEL) switches data to be communicated to Sensor Data (SENSD) provided from a sensor, Batch Transmission Data (CMBD) accumulated in the past, and Firmware Update Data (FMUD) by External Power Source Detecting Signal (PDETS).

Illumination Sensors (LS1F, LS1B) are respectively mounted to a front face and a rear face of Nameplate Type Sensor Node (TR). Data acquired by Illumination Sensors (LS1F, LS1B) are stored to Storage Portion (STRG) by Sensor Data Store Control Portion (SDCNT), and at the same time, compared by Front/Rear Detection (FBDET). When the nameplate is correctly mounted, Illumination Sensor (front) (LS1F) mounted to a front face receives external light, and Illumination Sensor (rear) (LS1B) mounted to a rear face does not receive external light owing to a positional relationship of interposing Illumination Sensor (rear) (LS1B) between a main body of Nameplate Type Sensor Node (TR) and a wearing person. At this occasion, an illuminance detected by Illumination Sensor (front) (LS1F) makes a value larger than that of an illuminance detected by illumination Sensor (rear) (LS1B). On the other hand, in a case where front/rear of Nameplate Type Sensor Node (TR) are reversed, Illumination Sensor (rear) (LS1B) receives external light, and Illumination Sensor (front) (LS1F) is directed to a side of the wearing person. Therefore, an illuminance detected by Illumination Sensor (rear) (LS1B) becomes larger than an illuminance detected by Illumination Sensor (front) (LS1F).

Here, it can be detected that front/rear of the node are reversed, and the nameplate node is not correctly mounted by comparing an illuminance detected by Illumination Sensor (front) (LS1F) and an illuminance detected by Illumination Sensor (rear) (LS1B) by Front/Rear Detection (FBDET). When reversal of front/rear is detected by Front/Rear Detection (FBDET), an alarm sound is generated and notified to the wearing person by Speaker (SP).

Microphone (AD) acquires voice information. By voice information, a surrounding environment of “noisy” or “quiet” can be known. Further, by acquiring and analyzing voice of a person, there can be analyzed a meeting communication of whether a communication is active or stagnant, whether a conversation is exchanged equally to each other or one-directionally talked, whether a person gets angry or laughs, and so on. Further, a meeting state which cannot be detected by Infrared Ray Transmitter/Receiver (AB) in relation to a standing position of a person or the like can also be supplemented by voice information and acceleration information.

As voice acquired by Microphone (AD), both of a voice waveform and a signal of integrating the voice waveform by Integrating Circuit (AVG) are acquired. The integrated signal represents an energy of acquired voice.

Triaxial Acceleration Sensor (ACC) detects an acceleration of a node, that is, a motion of a node. Therefore, there can be analyzed an intensity of a motion of a person who is mounted with Nameplate Type Sensor Node (TR), and an action of walking or the like from acceleration data. Further, by comparing values of accelerations detected by plural Nameplate Type Sensor Nodes (TR), there can be analyzed an activity or a mutual rhythm, a mutual correlation or the like of a communication between persons who are mounted with Nameplate Type Sensor Nodes (TR).

In Nameplate Type Sensor Node (TR) of the present embodiment, data acquired by Triaxial Acceleration Sensor (ACC) is stored to Storage Portion (STRG) by Sensor Data Store Control Portion (SDCNT), and at the same time, a direction of the nameplate is detected by Up/Down Detection (UDDET). The detection utilizes the fact that as accelerations detected by Triaxial Acceleration Sensor (ACC), there are observed 2 kinds of a dynamic change in an acceleration by a motion of a wearing person, and a static acceleration by the gravitational acceleration of the globe.

When Nameplate Type Sensor Node (TR) is mounted to the breast, Display Device (LCDD) displays individual information of a professional position, a name or the like of a wearing person, that is, behaves as a nameplate. On the other hand, when a wearing person holds Nameplate Type Sensor Node (TR) by the hand, and directs Display Device (LCDD) to the wearing person per se, top/bottom of Nameplate Type Sensor Node (TR) are reversed. At this occasion, contents displayed on Display Device (LCDD) and functions of buttons are switched by Up/Down Detection Signal (UDDETS) generated by Up/Down Detection (UDDET). According to the present invention, there is shown an example in which by a value generated by Top/Down Detection (UDDETS), information displayed on Display Device (LCDD) is switched to an analysis result by Infrared Ray Activity Analysis (ANA) generated by Display Control (DISP), and Nameplate Display (DNM).

By exchanging infrared rays between nodes by Infrared Ray Transmitter/Receiver (AB), it is detected whether Nameplate Type Sensor Node (TR) meets other Nameplate Type Sensor Node (TR), that is, whether a person who is mounted with Nameplate Type Sensor Node (TR) meets a person who is mounted with other Nameplate Type Sensor Node (TR). Therefore, it is preferable to mount Nameplate Type Sensor Node (TR) in a front direction of a person. As described above, Nameplate Type Sensor Node (TR) further includes sensors of Triaxial Acceleration Sensor and the like. A process of sensing at Nameplate Type Sensor Node (TR) corresponds to Organization Dynamics Data Acquire (A) in FIG. 2A.

There are present plural Nameplate Type Sensor Nodes (TR) in a number of cases, and respective Nameplate Type Sensor Nodes (TR) are connected to near Base Station (GW) to create Personal Area Network (PAN).

Temperature Sensor (AE) of Nameplate Type Sensor Node (TR) acquires a temperature of a location at which Nameplate Type Sensor Node (TR) is present. Illumination Sensor (front) (LS1F) acquires an illuminance in a front direction of Nameplate Type Sensor Node (TR). Thereby, a surrounding environment can be recorded. For example, it can also be known that Nameplate Type Sensor Node (TR) is moved from a certain location to other location on the basis of temperature and illuminance.

An input/output device in correspondence with a person who is mounted with Nameplate Type Sensor Node (TR) includes Buttons 1 through 3 (BTN 1 through 3), Display Device (LCDD), Speaker (SP) and the like.

Storage Portion (STRG) is configured specifically by a nonvolatile storage device of a hard disk, a flash memory or the like. Storage Portion (STRG) is recorded with Terminal Information (TRMT) which is an inherent identifying number of Nameplate Type Sensor Node (TR) and Motion Set (TRMT) of an interval of sensing, contents outputted to a display and the like. Otherwise, Storage Portion (STRG) can temporarily record data and is utilized for recording sensed data.

Communication Timing Control Portion (TRTMG) is a clock of holding Time Information (GWCSD) and updating Time Information (GWCSD) at constant intervals. Time information corrects time periodically by Time Information (GWCSD) transmitted from Base Station (GW) in order to prevent Time Information (GWCSD) from being shifted from that of other Nameplate Type Sensor Node (TR).

Sensor Data Store Control Portion (SDCNT) controls sensing intervals or the like of respective sensors in accordance with Motion Set (TRMA) recorded to Storage Portion (STRG), and controls acquired data.

Time Synchronization corrects a clock by acquiring time information from Base Station (GW). Time synchronization may be executed immediately after associate described later, or may be executed in accordance with a time synchronization command transmitted from Base Station (GW).

Wireless Communication Control Portion (TRCC) carries out a control of a transmission interval, and a conversion to a data format in correspondence with transmission/reception in transmitting/receiving data. Wireless Communication Control Portion (TRCC) may have a communication function not by wireless but by wire as necessary. Wireless Communication Control Portion (TRCC) may carry out a congestion control such that a transmission timing of Nameplate Type Sensor Node (TR) and that of other Nameplate Type Sensor Node (TR) do not overlap.

Associate (TRTA) transmits and receives Associate Request (TRTAQ) and Associate Response (TRTAQ) for creating Personal Area Network (PAN) to and from Base Station (GW) shown in FIG. 1G, and determines Base Station (GW) to which data is to be transmitted. Associate (TRTA) is executed when a power source of Nameplate Type Sensor Node (TR) is made ON, and when transmission/reception to and from Base Station (GW) up to that time is cut as a result of moving Nameplate Type Sensor Node (TR). As a result of Associate (TRTA), Nameplate Type Sensor Node (TR) is related to one Base Station (GW) which is disposed in a near range which a wireless signal from Nameplate Type Sensor Node (TR) reaches.

Transmitting/Receiving Portion (TRSR) includes an antenna, and carries out transmission/reception of a wireless signal. Transmitting/Receiving Portion (TRSR) can also carry out transmission/reception by using a connector for wired communication as necessary. For example, there may be provided a connector which is connected to a cradle at which Nameplate Type Sensor Node (TR) is placed when a person is not mounted with Nameplate Type Sensor Node (TR). Transmitting/Receiving Data (TRSRD) transmitted and received by Transmitting/Receiving Portion (TRSR) is transferred via Personal Area Network (PAN) to and from Base Station (GW).

FIG. 2A, FIG. 2B, FIG. 2C, and FIG. 2D show a total flow of processings executed in the business microscope system according to one embodiment. Although processings are dividedly shown for convenience of illustration, the respective processings which are respectively illustrated are executed in cooperation with each other. There is shown a series of flows in which a visualization is carried out from Organization Dynamics Data Acquire (A) by plural Nameplate Type Sensor Nodes (TRa, TRb, -, TRi, TRj) shown in FIG. 2A to Business Action Analysis (CA) which is an analysis of sensor data shown in FIG. 2D, and Project Progress Contents Generate (JA) in FIG. 2D from a result of analysis, and a result of visualization is Project Progress Contents (KA).

An explanation will be given of Organization Dynamics Data Acquire (A) in reference to FIG. 2A. Nameplate Type Sensor Node A (TRA) includes sensors of Infrared Ray Transmitter/Receiver (AB), Acceleration Sensor (AC), Microphone (AD), Temperature Sensor (AE) and the like, and buttons of Buttons (AF) of Net Ability (AFA), Notice (AFB), and Acknowledgement (AFC).

There are included Display (AG) of displaying meeting information provided from Infrared Ray Transmitter/Receiver (AB), User Interface (AA) of inputting rating, and a microcomputer and a wireless transmission function although illustration thereof is omitted.

Acceleration Sensor (AC) detects an acceleration of Nameplate Type Sensor Node A (TRa) (that is, an acceleration of person A) (not illustrated) who is mounted with Nameplate Type Sensor Node A (TRa). Infrared Ray Transmitter/Receiver (AB) detects a meeting state of Nameplate Type Sensor Node A (TRa) (that is, a state in which Nameplate Type Sensor Node A (TRa) meets other nameplate type sensor node). Further, that Nameplate Type Sensor Node A (TRa) meets other nameplate type sensor node signifies that person A who is mounted with Nameplate Type Sensor Node A (TRa) meets a person who is mounted with other nameplate type sensor node. Microphone (AD) detects surrounding sound of Nameplate Type Sensor Node A (TRa). Temperature Sensor (AE) detects a surrounding temperature of Nameplate Type Sensor Node A (TRa).

Buttons (AF) carry out inputs from a subjective view point of person A (not illustrated) who is mounted with Nameplate Type Sensor Node A (TRa). In a case where a main business is carried out, a button of Net Ability (AFA) is pressed down. In a case where a new idea or the like is discovered, a button of Notice (AFA) is pressed down. In a case where an acknowledgement is made to a member, a button of Acknowledgement (AFC) is pressed down.

A system of the present invention includes plural nameplate type sensor nodes (Nameplate Type Sensor Node A (TRa-Nameplate Type Sensor Node J (TRj) of FIG. 2A). Respective nameplate type sensor nodes are respectively mounted to single persons. For example, Nameplate Type Sensor Node A (TRa) is mounted to person A, and Nameplate Type Sensor Node B (TRb) is mounted to person B (not illustrated). This is for analyzing a relationship among persons and illustrating a performance of an organization.

Further, Nameplate Type Sensor Node B (TRb)-Nameplate Type Sensor Node J (TRj) also include sensors, microcomputers, and wireless transmission functions similar to Nameplate Type Sensor Node A (TRa). In the following explanation, in a case where there is carried out an explanation which is fitted to any of Nameplate Type Sensor Node A (TRa)-Nameplate Type Sensor Node J (TRj), and in a case where the nameplate type sensor nodes are not necessarily needed to particularly distinguish, an expression of nameplate type sensor node is described.

Respective nameplate type sensor nodes execute sensing always (or repeatedly at short intervals) by sensors. Further, each nameplate type sensor node transmits acquired data (sensing data) by wireless at predetermined intervals. Further, each nameplate type sensor node transmits also data inputted by Buttons (AF), and rating inputted by User Interface (AA). An interval of transmitting data may be the same as a sensing interval, or may be an interval larger than the sensing interval. Data transmitted at this occasion is provided with inherent Identifier (ID) of a sensing nameplate type sensor node. Wireless transmission of data is summarizingly executed for maintaining a usable state of Nameplate Type Sensor Node (TR) for a long period of time while a person is mounted therewith by restraining power consumption by transmission. Further, it is preferable that the same sensing interval is set in all of nameplate type sensor nodes for later analysis. Further, respective data may be transmitted by wire.

Data transmitted from nameplate type sensor nodes by wireless/wire is collected at Organization Dynamics Data Collect (B) shown in FIG. 2B and FIG. 2C, and stored at a database. For example, data is stored to Storage Portion (SSME) of Sensor Net Server (SS).

Performance Table (BB) stores values of performances inputted at Performance Input (C) and Rating Input (AA).

User ID (BBA) is an identifier of a user. Acquire Time (BBB) is time of carrying out Rating Input (AA) at Nameplate Type Sensor Node (TR), or time of carrying out Performance Input (C). SOCIAL (BBC), INTELLECTUAL (BBD), SPIRITUAL (BBE), PHYSICAL (BBF), EXECUTIVE (BBG) are rating contents. Terminal (BBH) is terminal information (for example, an identifier of a nameplate type sensor node). Store Time (BBI) is time of storing to Performance Table (BB).

Data Table (BA) stores sensor data obtained from a nameplate type sensor node. User ID (BAA) is an identifier of a user. Acquire Time (BAB) is time of receiving data from Nameplate Type Sensor Node (TR). Base Station (BAC) is a base station from which Nameplate Type Sensor Node (TR) receives signals. Acceleration Sensor (BAD) is sensor data of Acceleration Sensor (AC). IR Sensor (BAE) is sensor data of Infrared Ray Transmitter/Receiver (AB). Sound Sensor (BAF) is sensor data of Microphone (AD). Temperature Sensor (BAG) is sensor data of Temperature Sensor (AE). Illumination Sensor (BAH) is sensor data of Illumination Sensor (front) (LS1F) and Illumination Sensor (rear) (LS1B). Notice (BAI) is whether Notice (AFB) button is pressed down. Acknowledgement (BAJ) is whether Acknowledgement (AFC) button is pressed down. Net Ability (BAK) is whether Net Ability (AFA) button is pressed down. Terminal (BA) is terminal information (for example, an identifier of a nameplate type sensor node). Store Time (BAN) is time of storing to Performance Table (BA). Checker flag (BAN) is a flag of determining whether data is acquired. For example, 0 is substituted for the flag in a case where a user is mounted with a nameplate type sensor node, and 1 is substituted therefor in a case where a user is not mounted with a nameplate type sensor node. Mounted/not mounted may be recognized by detecting whether a nameplate type sensor node is placed at a cradle by a nameplate type sensor node, or may be recognized by detecting a prescribed operation of making a power source on/off of a nameplate type sensor node, or may be recognized by a pertinent method other than these.

Further, in Dynamics Data Collect (B), data is stored in an order in which data reaches Dynamics Data Collect (B). Therefore, data is not necessarily in an order of time.

Further, Data Table (BA) is only an example, and the table may be created for each sensor data.

Further, as data indicating that sensing is not carried out, for example, Null data is stored. In the present embodiment, there is a case where that Null is stored and that data cannot be received and data is not stored are distinguished.

By organization dynamics data collected by Organization Dynamics Data Collect (B), project progress contents are generated by Business Action Analysis (CA) shown in FIG. 2D, and visualized by Project Progress Contents Generate (JA), and a result of the visualization becomes Project Progress Contents (KA).

One of objects of the business microscope is making clear the project progress by Business Index Analysis (CA1) of Business Action Analysis (CA). Contents are generated by a periodical batch processing. However, a timing of sending sensor data is not constant. Therefore, there is a case where sensor data cannot be analyzed by the periodical batch processing. In order to improve an accuracy of contents, it is necessary to reflect unprocessed data. However, when the batch processing is reexecuted, also data which has been processed in the past is processed. Therefore, the processing is wasteful. Project progress contents are created in consideration of making a reduction in an amount of an analysis processing of data and an increase in an accuracy of contents compatible.

An explanation will be given of a total flow of Business Index Analysis (CA1) in reference to FIG. 2D.

First, a project which becomes an object of Business Index Analysis (CA1) of Business Action Analysis (CA) is a project which is registered with respective pieces of information related to the project by Mission Register (KA2) of Project Progress Contents (KA) and which is registered to Project Table (FAF) of Analysis Result Database (F).

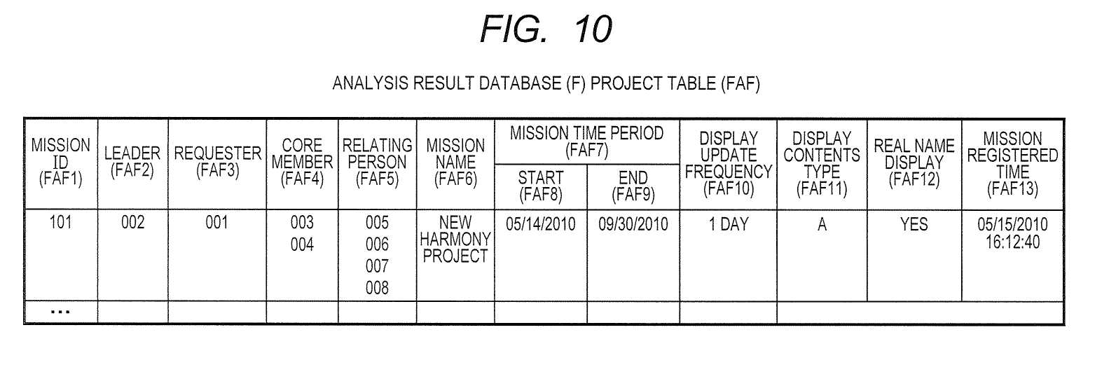

An explanation will be given of Project Table (FAF) in reference to FIG. 10. In order to generate contents by using a result by Mission Register (KA2) of Project Progress Contents (KA), it is necessary to register contents described (inputted) in mission register to a database. An example of the storing is Project Table (FAF) of Analysis Result Database (F) of FIG. 10.

Mission ID (FAF1) is an ID for identifying a mission. It is preferable to assign an ID which does not overlap an ID of other mission. Leader (FAF2) is a leader in mission register. This is a member who arranges the mission. Requester (FAF3) is a requester in mission register. For example, the requester is preferably an originator who sets up the mission. Core Member (FAF4) is a core member in mission register. This is a member who materializes the mission. Relating Person (FAF5) is a relating person in mission register. Although the person is not a person concerned for realizing the mission, the person is a related person of members who materializes the mission. Mission Name (FAF6) is a title in mission register. This is the name of the mission. Mission Time Period (FAF7) is a time period in mission register. Start day/time of the mission is described in Start (FAF8), and scheduled end day/time is described in End (FAF). Display Update Frequency (FAF10) describes a frequency of updating contents display. Ordinarily, this is an interval which is previously determined by a unit of a system of 1 day or the like. However, in a case where updating of a high frequency is desired, desired updating time can be described for each mission. There are plural types of display contents, and Display Contents Type (FAF11) is used for selecting display contents described with desired display contents from the plural types of display contents.

Real Name Display (FAF12) designates whether a name displayed in contents is a real name or a pseudonym. For example, in a case where a real name is desired, “Yes” is selected. In a case where a pseudonym is desired, “No” is selected.

Mission Registered Time (FAF13) describes time registered by mission register.

Further, in mission register, in a case where the mission register is described by a name of a user, the name of the user may be stored to Project Table (FAF) after converting the name of the user into user ID by using User ID Table (IA).

Further, in carrying out the processing, in a case where a table of corresponding user name and user ID is needed, User/Location Information Database (I) may be used.

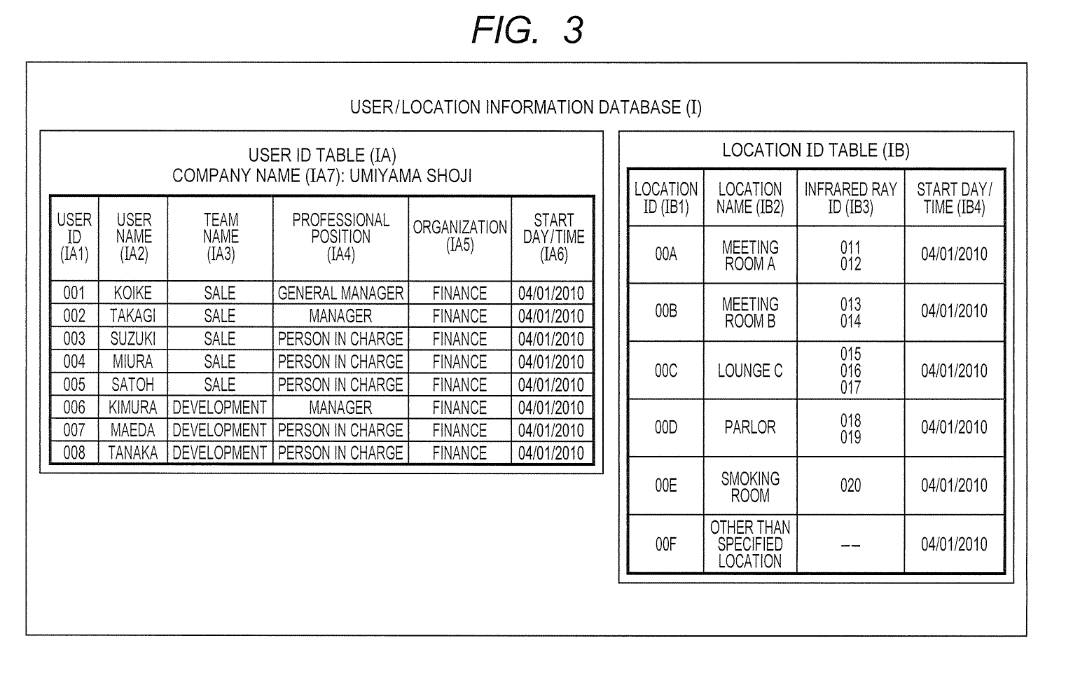

An explanation will be given of User ID Table (IA) of User/Location Information Database (I) in reference to FIG. 3. FIG. 3 shows an example of the table. User ID Table (IA) is a table for relating pieces of information of a user ID and a name (user name) and a team name or the like. For example, the table is configured by User ID (IA1), User Name (IA2), Team Name (IA3), Professional Position (IA4), Organization (IA5), Start Day/Time (IA6), and Company Name (IA7).

Next, an explanation will be given of Location ID Table (IB) of User/Location Information Database (I). FIG. 3 shows an example of the table. Location ID Table (IB) is a table for relating a location ID and a location name and an infrared ray ID. For example, the table is configured by Location ID (IB1), Location Name (IB2), and Infrared Ray ID (IB3). Location Name (IB2) is a name of the location, and Infrared Ray ID (IB3) is an ID of an infrared ray terminal installed at Location ID (IB1). Plural pieces of infrared ray terminals may be installed to one location. In a case where plural pieces of infrared ray terminals are installed, Infrared Ray ID (IB3) is described with plural infrared ray ID's. Further, Start Day/Time (IB4) shows day/time of starting the installation.

An explanation will be given of processings by referring back to FIGS. 2A, 2B, 2C, and 2D. Respective processings of Business Index Analysis (CA1) explained below are executed by Control Portion (ASCO) of Application Server (AS) (analysis server). In Time Period Start (CA1EA), it is determined whether a time period is a corresponding time period by using Mission Time Period (FAF7) of information registered in Project Table (FAF). For example, in a case where a mission time period includes current time, the time period can be determined as the corresponding time period.

In Member Start (CA1FA), it is determined whether the member is a corresponding member by using Leader (FAF2) or Core Member (FAF4) of information registered to Project Table (FAF). Further, Requester (FAF3) or Relating Person (FAF5) may be included in the analysis. The following processing is carried out for the corresponding member of the mission in the corresponding time period.

In Business Index Analysis (CA1), in order to make a reduction in an amount of an analysis processing of data and an increase in an accuracy of contents compatible, in calculating Individual Index (CA1B), Individual Acquiring Rate Confirm (CA1A1) is carried out before the processing, an acquiring rate used in an analysis at a preceding time is confirmed. In a case where the acquiring rate is improved, the corresponding batch processing is reprocessed for updating the index.

In Individual Acquiring Rate Confirm (CA1A1), a data acquiring rate is calculated by referring to Checker flag (BAN) of Data Table (BA). For example, a data acquiring rate is calculated by counting a number of Checker flag (BAN) by making other than mounted or not mounted one unclear by Checker flag (BAN). Further specifically, a reference is made to Checker flag (BAN) in correspondence with a user ID of a corresponding member which is stored in Data Table (BA) of Sensor Net Server (SS). For example, a reference is made to Checker flag (BAN) from preceding analysis time to current time. Further, a data number which is to be acquired during a time period from preceding analysis time to current time (complete acquiring number, desired data number) is determined by time resolution of sensing. A data acquiring rate is calculated by counting numbers of 0 and 1 of Checker flag (BAN), and dividing counted values (effective data numbers) by a complete acquiring number. Further, as a data acquiring rate, other than a data acquiring rate by calculating a rate of capable of acquiring rate, by making other than mounted or not mounted one as unclear data, and an unclear number is calculated, and a calculated unclear number may be divided by a number of data which is to be acquired (data deficiency rate). In a case of using a rate of capable of acquiring data and in a case of using a rate of an unclear number, determination in improving an acquiring rate (for example, a direction of an inequality sign) is reversed.

In determining Individual Acquiring Rate Confirm (CA1A1), Individual Processing Reference Table (FAA) of Analysis Result Database (F) is used.

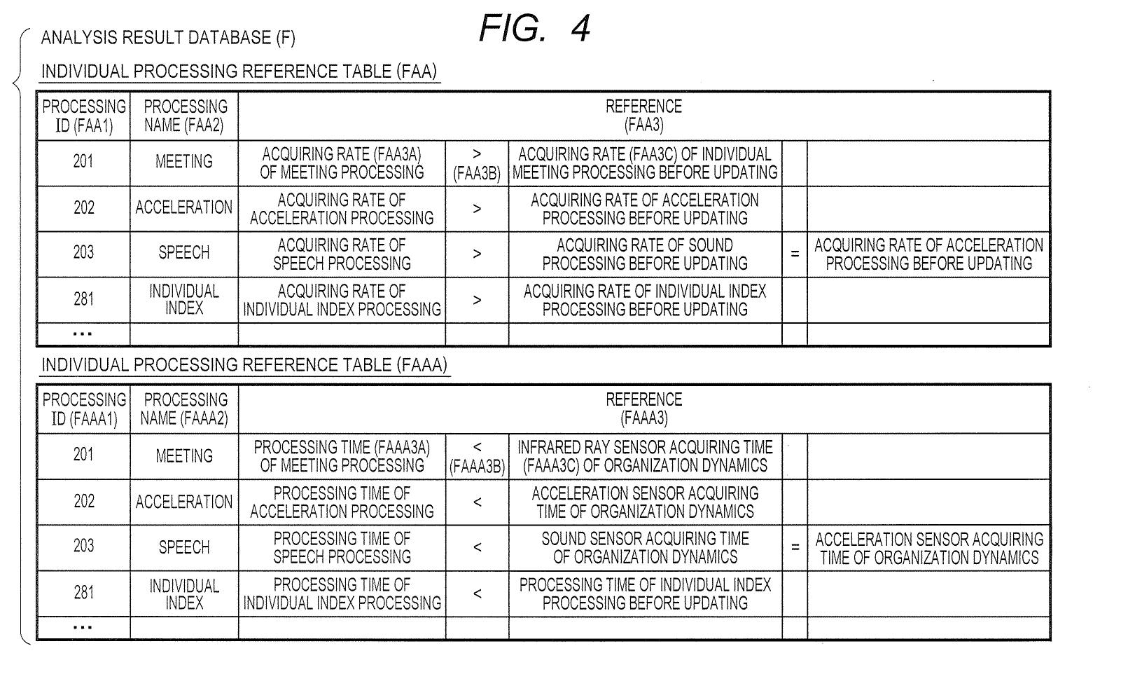

FIG. 4 shows an example of Individual Processing Reference Table (FAA) of Analysis Result Database (F). In Individual Processing Reference Table (FAA), a determination is carried out by a data acquiring rate. Processing ID (FAA1) is an identification number of, for example, a processing (batch processing), and the processing is controlled by the ID. Further, a processing program thereof is stored in Analysis Algorithm (D). Processing Name (FAA2) is a name of a processing. Reference (FAA3) shows a conditional expression of whether a processing is executed. In a case where an equation of an inequality sign or an equality sign described in Reference (FAA3) is used, and the conditional expression is matched, Individual Action Specify (CA1A2) is carried out. For example, in a meeting processing of FIG. 4, it is described that Acquiring Rate of Meeting Processing (FAA3A)>(FAA3B), Acquiring Rate of Meeting Processing (FA3C) before updating. This shows that in a case where an acquiring rate at current time is larger than an acquiring rate before updating, a corresponding meeting processing is executed. The acquiring rate before updating (preceding time) is stored at Acquiring Rate (FAB9) of Individual Processing Time Execute Log Table (FAB) in correspondence with a processing ID. Further, in a case where the conditional expression is matched, as described later, Acquiring Rate (FAB9) of Individual Processing Time Execute Log Table (FAB) in correspondence with a corresponding processing ID and a corresponding user ID is updated to an acquiring rate which is calculated at current time.

Here, “acquiring rate of meeting processing” in the drawing is an acquiring rate of data used in the meeting processing (specifically, sensing data of an infrared ray sensor). Similarly, “acquiring rate of acceleration processing” is an acquiring rate of sensing data of an acceleration sensor, and “acquiring rate of speech processing” is an acquiring rate of sensing data of a sound sensor. In a case of “acquiring rate of individual index processing”, Data Table (BA) is not directly read as in a meeting processing or the like, but an average of “acquiring rate of meeting processing” and “acquiring rate of acceleration processing” and “acquiring rate of speech processing”, or a minimum acquiring rate thereof is used. Respective acquiring rates are pertinently stored, and can be referred to.

Further, a conditional expression can be changed by arbitrarily changing Reference (FAA3).

Further, by providing a threshold (second threshold) for a degree of changing an acquiring rate, a processing can also be executed in a case where there is a change in an acquiring rate by a certain constant value or more. For example, a processing is executed in a case where a change in an acquiring rate (for example, an increase) is equal to or more than 5 points or the like.

Further, an upper limit (first threshold) of an acquiring rate may previously be determined, and even when an acquiring rate is equal to or more than the upper limit, a processing can also be made not to execute. For example, when an acquiring rate is equal to or more than 98%, even if the acquiring rate is equal to or more than 98%, a processing is made not to execute again or the like. In this case, an analysis server determines a state of finishing an analysis.

Further, a determination under plural references can be made, and an analysis of only a corresponding processing ID can be executed from a result of a determination.

Further, a determination under plural references can be made, and when even one conditional expression is matched, a processing can be executed for all of processing ID's.

Although a description has been given of an acquiring rate in Individual Processing Reference Table (FAA), in Individual Processing Reference Table (FAAA), a determination is carried out by processing time. Processing ID (FAAA1) is, for example, an identifying number of a processing, and a processing is carried out by ID. Further, a processing program thereof is stored to Analysis Algorithm (D). Processing Name (FAAA2) is a name of a processing. Reference (FAAA3) shows a conditional expression of whether a processing is executed. By using an equation of an inequality sign or an equality sign described in Reference (FAAA3), in a case where the conditional expression is matched, Individual Action Specify (CA1A2) is carried out.

For example, in FIG. 4, it is described that Processing Time (FAAA3A) of a meeting processing<(FAAA3B), Infrared Ray Sensor Acquiring Time (FAAA3C) of an organization dynamics. This shows that a processing is executed in a case where processing time of a meeting processing is earlier than infrared ray sensor acquiring time.

A conditional expression can be changed by arbitrarily changing Reference (FAAA3). Further, by providing a threshold in a difference of processing time, a processing can also be executed in a case where there is a constant or more time difference. Further, a determination under plural references can be carried out and an analysis of only a corresponding processing ID can be executed from a result of the determination. Further, a determination under plural references can be carried out, and a processing can be executed for all of processing ID's when even one conditional expression is matched.

In a case where analysis of Individual Action (CA1A) is determined to be necessary by Individual Acquiring Rate Confirm (CA1A1), Individual Action Specify (CA1A2) of Individual Action (CA1A) is carried out. In this case, a log of a processing result which is carried out by Individual Action Specify (CA1A2) is described in Individual Processing Execute Log(FAB).

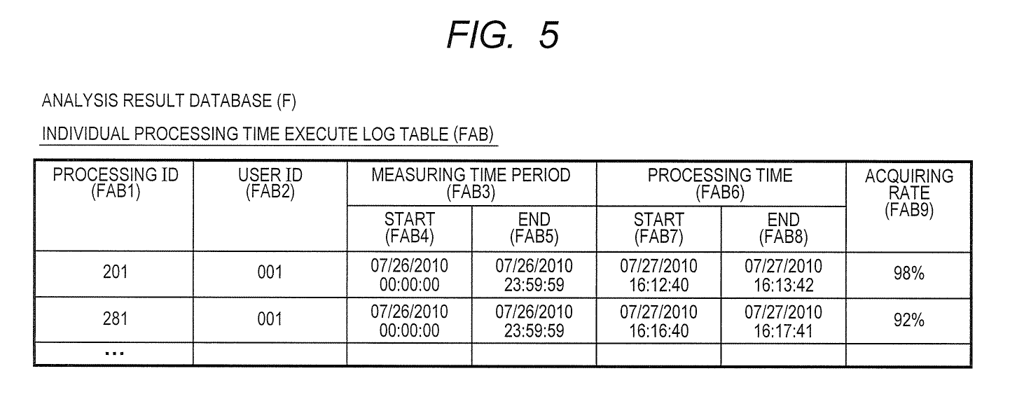

FIG. 5 shows an example of Individual Processing Time Execute Log Table (FAB) of Analysis Result Database (F). This is a table which describes a log of a result of execution by Individual Action Specify (CA1A2) by a determination of Individual Processing Reference Table (FAA). Processing ID (FAB1) is, for example, an identification number of a processing, and the processing is controlled by ID. Further, a processing program thereof is stored to Analysis Algorithm (D). User ID (FAB2) is an ID of a user. Measuring Time Period (FAB3) is described with a time period of measuring sensor data (for example, measuring time period of sensor data which becomes an object of a processing), Start (FAB4) is measuring start time, and End (FAB5) is measuring finish time. Processing Time (FAB6) is described with time of a processing, Start (FAB7) is processing start time, and End (FAB8) is processing finish time. Acquiring Rate (FAB9) shows a degree of acquiring sensor data.

An acquiring rate is an acquiring rate calculated by Individual Acquiring Rate Confirm (CA1A1) as described above, or a value of dividing an effective data number of a complete acquiring number of Meeting Table (FAC) of Analysis Result Database (F) or Body Rhythm Table (FAD) of Analysis Result Database (F) in a corresponding time period or a user subtracted by an unclear number by the complete acquiring number as described later. The complete acquiring number depends upon a time resolution, and is 1440 per 1 day in a case of Time Resolution 1 Minute (FAD3).

In Individual Action Specify (CA1A2), an analysis is carried out by using data of a corresponding user from Organization Dynamics Data Collect (B). An explanation will be given of processings of Meeting Table Create (CA1A2A) and Body Rhythm Create (CA1A2B) of Individual Action Specify (CA1A2).

Meeting Table Create (CA1A2A) summarizes a meeting situation among members from infrared ray data of organization dynamics data in a time-sequential order at every constant time period.

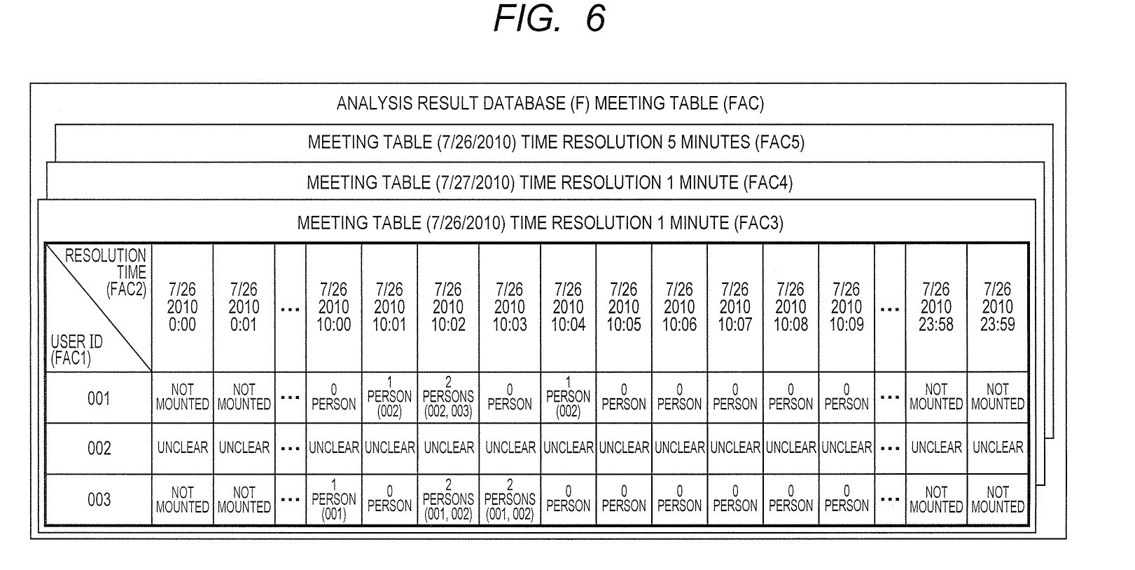

An extracted result is stored to Meeting Table (FAC) of Analysis Result Database (F). FIG. 6 shows an example of Meeting Table (FAC). According thereto, an amount of 1 day (24 hours) is stored in a time-sequential order with a user as 1 record and with Time Resolution 1 Minute (FAC3). 1 table is for 1 day, Table (FAC4) of a time resolution 1 minute of a meeting table (Jul. 27, 2010) is a table of a day successive to Table (FAC3) of a time resolution 1 minute of a meeting table (Jul. 26, 2010).

Further, 1 table is preferably for each time resolution. Although a table of Time Resolution 5 Minutes (FAC5) is a table of Jul. 27, 2010 which is the same as a day of a table of Time Resolution 1 Minute (FAC). However, a table of Time Resolution 1 Minute (FAC3) and a table of Time Resolution 5 Minutes (FAC5) are different from each other.

In meeting table (Jul. 26, 2010) of Time Resolution 1 Minute (FAC), the ordinate is User ID (FAC1) for determining an individual member, and the abscissa is Resolution Time (FAC2) indicating time by time resolution. As a meeting situation of a user at certain time, only a portion of the meeting table in correspondence with User ID (FAC1) and Resolution Time (FAC2) may be read. For example, as a meeting situation of a member of User ID of 001 at Jul. 26, 2010, 10:02, a member meets two members, and a member of user ID of 001 meets members 002 and 003.

Further, “not mounted” is stored in a case where it is determined that the user is not mounted with the nameplate type sensor node. For example, at time of receiving data indicating that each sensor is not sensing (Null data) by placing a nameplate type sensor node at a cradle, data indicating “not mounted” is stored.

Further, “unclear” is a case where it cannot be determined whether a nameplate type sensor is mounted. For example, at time at which also data indicating that even sensor data is not sensed, data indicating “unclear” is stored.

Further, it is important for Meeting Table (FAC) that the table is stored with a member of user ID who meets a number of meeting persons. Therefore, so far as this is satisfied, a table configuration may differ from that used in Meeting Table (FAC).

Body Rhythm Table Create (CA1A2B) summarizes a behavior/activity situation among members from acceleration data of organization dynamics data in a time-sequential order at each constant time period.

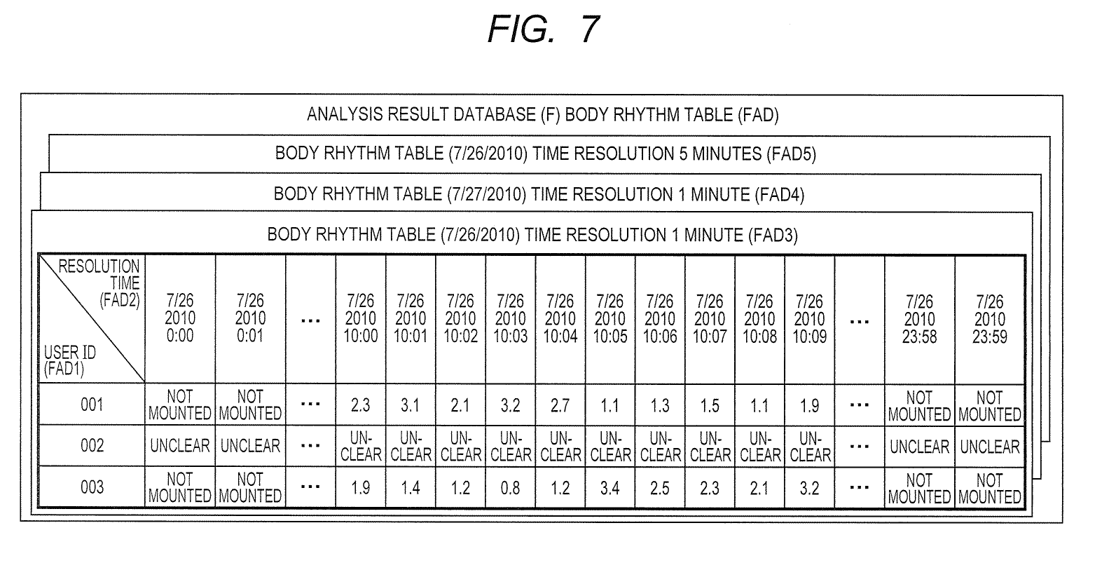

An extracted result is stored to Body Rhythm Table (FAD) of Analysis Result Database (F). FIG. 7 shows an example of Body Rhythm Table (FAD). According thereto, an amount of 1 day (24 hours) is stored in a time-sequential order with Time Resolution 1 Minute (FAD3) and with a user as 1 record. 1 table is for 1 day. Body Rhythm Table (Jul. 27, 2010) of Time Resolution 1 Minute (FAD4) is a table of a day successive to a day of Body Rhythm Table (Jul. 26, 2010) Time Resolution 1 Minute (FAD3).

Further, 1 table is preferably for each time resolution. Although a table of Time Resolution 5 Minutes (FAD5) is a table of Jul. 27, 2010 of a day the same as that of a table of Time Resolution 1 Minute (FAD3), the table of Time Resolution 1 Minute (FAD3) and the table of Time Resolution 5 Minutes (FAD5) differ from each other.

In Body Rhythm Table (Jul. 26, 2010) Time Resolution 1 Minute (FAD3), the ordinate is User ID (FAD1) for determining an individual member, and the abscissa is Resolution Time (FAD2) indicating time by time resolution. As a body rhythm of a user at certain time, a portion of the table in correspondence with User ID (FAD1) and Resolution Time (FAD2) may only read. For example, a body rhythm of Jul. 26, 2010, 10:02 of a person of a user ID of 001 is 2.1 Hz.

Further, “not mounted” is stored in a case where it is determined that a user is not mounted with a nameplate type sensor node. Further, “unclear” is a case where it cannot be determined whether a user is mounted with a nameplate type sensor node.

Further, it is important for Body Rhythm Table (FAD) that the body rhythm of a user is stored. Therefore, so far as this is satisfied, a table configuration may differ from that used in Body Rhythm Table (FAD).

In a processing of Individual Action (CA1A), an analysis may be carried out with regard to a corresponding user of Organization Dynamics Data collect (B). An analysis other than Meeting Table Create (CA1A2A), and Body Rhythm Table Create (CA1A2B) may be carried out. When a new processing is added, a new ID is assigned to Processing ID (FAA1) of Individual Processing Reference Table (FAA).

Further, data collected by Organization Dynamics Data Collect (B) can be used. A similar analysis may be carried out also for Sound Sensor (BAF), Temperature Sensor (BAG), Illumination Sensor (BAH), Notice (BAI), Acknowledgement (BAJ), or Net Ability (BAK) included in Data Table (BA) of Organization Dynamics Data Collect (B).

A processing of Consistency (CA1G) is a processing of analyzing a consistency among plural sensors which is provided by a processing of Individual Action (CA1A). A specific example is a consistency corresponding method when although data is stored to Meeting Table (FAC), and data is not stored to Body Rhythm Table (FAD) at time of a certain user. In requesting an accuracy, in a case where not a single sensor signal is acquired in plural sensors at the same time, there is a case where a problem is posed by using data thereof for an analysis.

Further, a processing amount is increased in consideration of a signal acquiring situation of a sensor which is not used for each analysis of each time. Therefore, it is preferable to carry out a consistency processing summarizingly before carrying out an analysis.

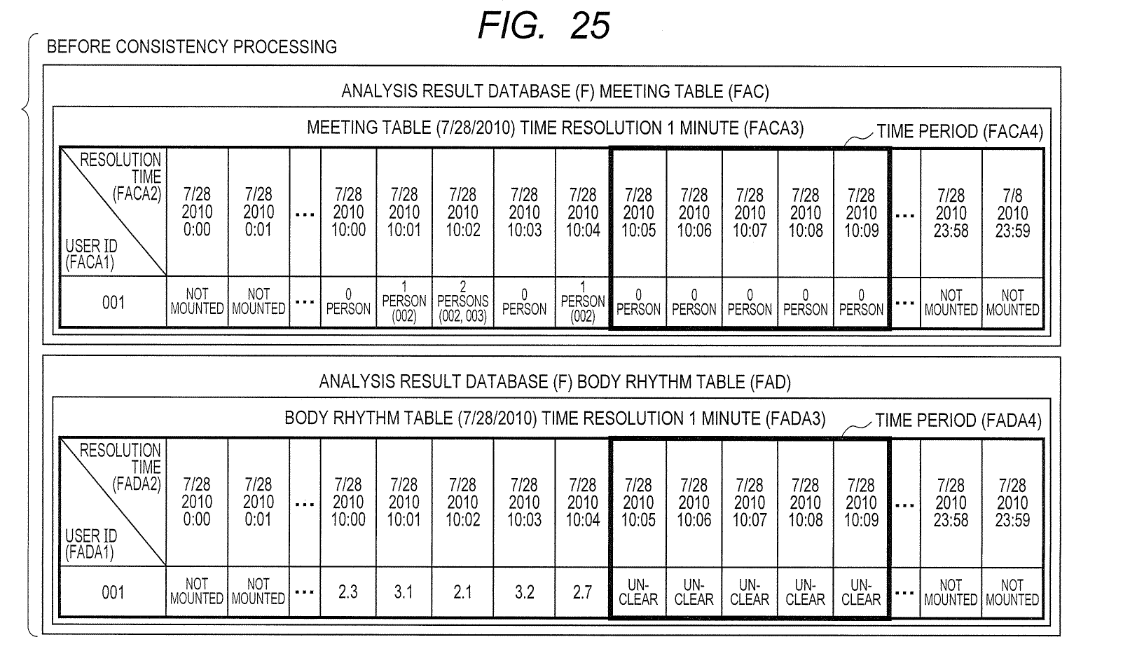

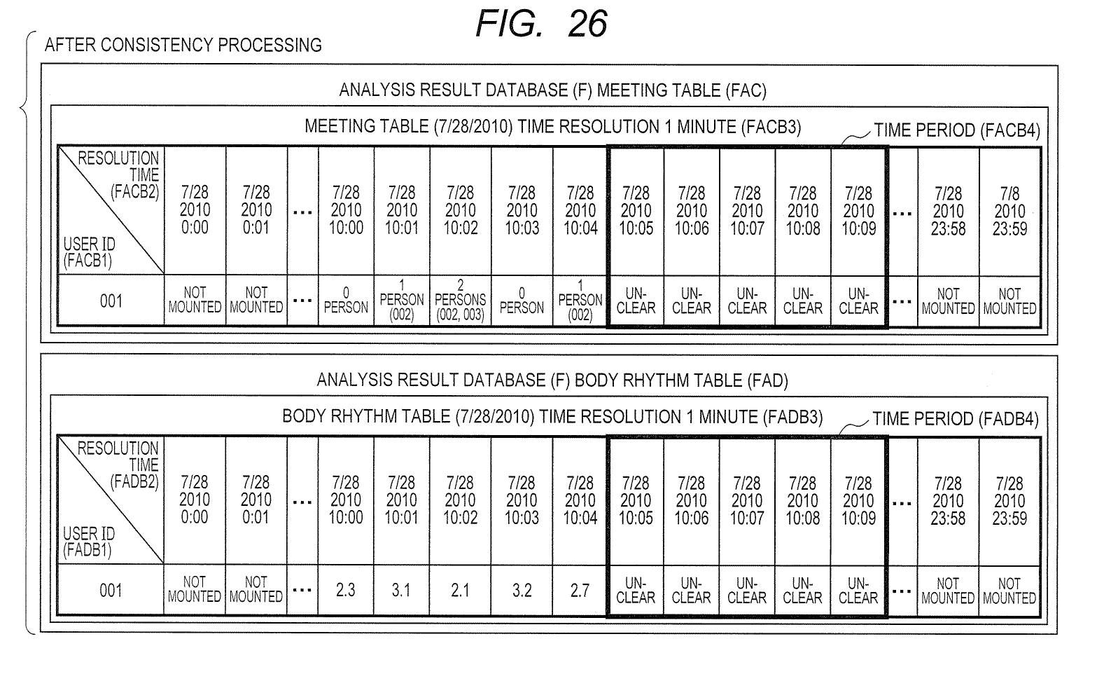

FIG. 25 and FIG. 26 show a method of dealing with Meeting Table (FAC) and Body Rhythm Table (FAD) in Analysis Result Database (F).

FIG. 25 shows Meeting Table (FAC) and Body Rhythm Table (FAD) before a consistency processing. First, an explanation will be given of an example of Meeting Table (FAC). According thereto, an amount of 1 day (24 hours) is stored in a time-sequential order with Time Resolution 1 Minute (FADA3) and with a user as 1 record. 1 table is for 1 day. The ordinate is User ID (FACA1) for determining an individual member, and the abscissa is Resolution Time (FADA2) indicating time by a time resolution. Next, an explanation will be given of an example of Body Rhythm Table (FAD). According thereto, an amount of 1 day (24 hours) is stored in a time-sequential order with Time Resolution 1 Minute (FAD1) and with 1 day as 1 table. 1 day is for 1 table. The ordinate is User ID (FADA1) detecting an individual member, and the abscissa is Resolution Time (FADA2) for indicating time by time resolution.

Further, in Time period (FADA4) of Body Rhythm Table (FADA4), data is not stored and is made to be unclear. In a corresponding Time Period (FACA4) of Meeting Table (FAC), data is stored.

In a case where a phenomenon described above is brought about, it is preferable to carry out a processing of Consistency (CA1G). As one example in correspondence with Consistency (CA1G), in a case where not a single sensor signal is acquired at the same time, it is determined that also other sensor signal is not accurately acquired, and sensor data at that time is made not to be used. FIG. 26 shows Meeting Table (FAC) and Body Rhythm Table (FAD) after a consistency processing by carrying out such a determination.

FIG. 26 is similar to FIG. 25, and therefore, an explanation will be given only of a changed portion. At a portion of Time Period (FACB4) of Meeting Table (FAC), data is changed to “unclear” indicating that data is not stored.

Thereby, ambiguous data can be prevented from being used in an analysis. Therefore, an analysis having a high accuracy can be carried out.

Further, in a case of a consistency processing in two or more of tables, it is preferable to be able to arbitrarily designate a sensor which is subjected to a consistency processing. Further, in a case of a consistency processing, it is preferable to use data having the same time resolution in 1 record of a table.

Further, it is preferable to recalculate an acquiring rate after a processing of Consistency (CA1G). In that case, an acquiring rate is calculated by using Meeting Table (FAC) and Body Rhythm Table (FAD) of Analysis Result Database (F). For example, an acquiring rate is calculated by dividing an effective data number of a complete acquiring number of Meeting Table (FAC) or Body Rhythm Table (FAD) subtracted by an unclear number by the complete acquiring number, and is pertinently stored to Individual Processing Time Execute Table (FAB) or the like.

In a processing of Individual Index (CA1B), an analysis is carried out on the basis of a result of carrying out an analysis in Individual Action (CA1A). At that occasion, a log of a result of a processing which is carried out by Individual Index (CA1B) is described in Individual Processing Execute Log Table (FAB).

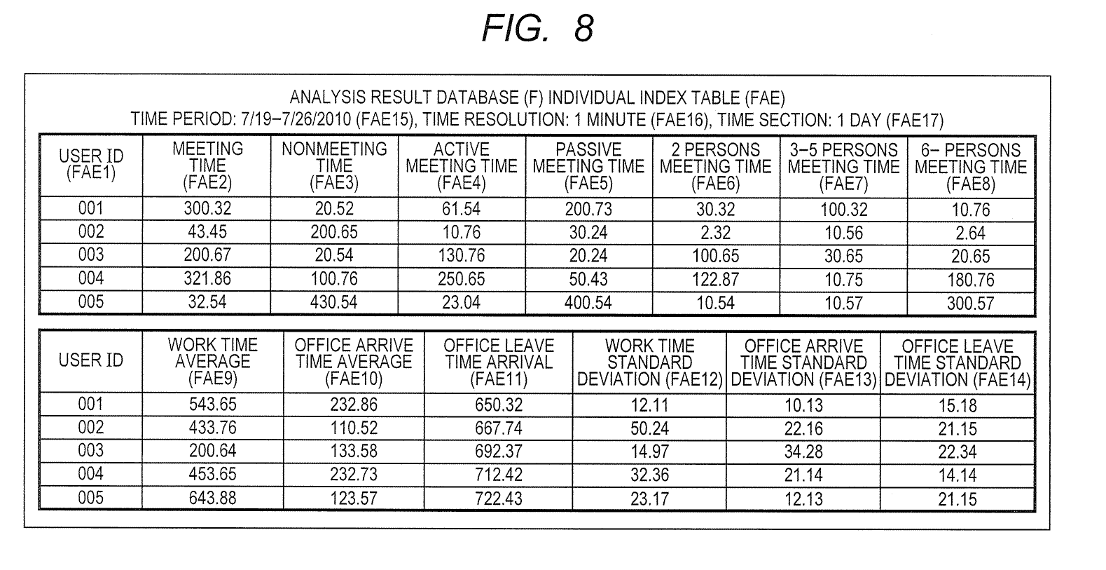

Individual Index (CA1B) is an index which is calculated from Meeting Table (FAC) and Body Rhythm Table (FAD) of Analysis Result Database (F) which is calculated by a processing of Individual Action (CA1A). Further, FIG. 8 shows Individual Index Table (FAE) as an example of a table which stores the index calculated by Individual Index (CA1B). Individual Index Table (FAE) is a table of storing an index for each user.

Individual Index Table (FAE) includes User ID (FAE1) of specifying a user and meeting indexes (Meeting Time (FAE2), No meeting Time (FAE3), Active Meeting Time (FAE4), Passive Meeting Time (FAE5), 2 Persons Meeting Time (FAE6), 3-5 Persons Meeting Time (FAE7), 6 or More Persons Meeting Time (FAE8)).

Time Period: Jul. 19-Jul. 26, 2010 (FAE15) indicates a time period used in analysis. Time Resolution: 1 minute (FAE16) is an analysis time resolution. Time Section: 1 Day (FAE17) is a range designation in calculating an average or the like in Time Period (FAE15).

There are calculated meeting time and nonmeeting time in acquiring organization dynamics data from Meeting Table (FAC). Meeting time is counted when a value stored in Meeting Table (FAC) is 1 person or more. No meeting time is counted when a value stored in Meeting Table (FAC) is 0 person. Meeting time and No meeting time are not counted in a case where the stored value is “not mounted” or “undetermined”. Meeting Time (FAE15) is time of counting meeting. No meeting Time (FAE3) is time of counting nonmeeting. Here, an analysis time resolution is 1 minute. Therefore, a counted value per se is time.

Active meeting or passive meeting is determined by investigating Body Rhythm Table (FAD) at that time among meeting members when meeting is determined by Meeting Table (FAC). As a threshold of the determination, active meeting is determined by body rhythm in meeting of 2 Hz or more, and passive meeting is determined by body rhythm in meeting of less than 2 Hz. Active Meeting Time (FAE4) is time of counting active meeting. Passive Meeting Time (FAE5) is time of counting passive meeting. An analysis time resolution is 1 minute, and therefore, a counted value per se is time.

It is investigated by what number of persons meeting is carried out from Meeting Table (FAC). In Meeting Table (FAC), a number of meeting persons is described for each analysis time resolution. Therefore, a value is calculated by counting the number of meeting persons. An analysis width is set to three of 2 persons, 3-5 persons, and 6 persons. 2 Persons Meeting Time (FAE6) is time of counting meeting by 2 persons. 3-5 Persons Meeting Time (FAE7) is time of counting meeting by 3 persons to 5 persons. 6 or More Persons Meeting Time (FAE8) is time of counting meeting by 6 persons or more. An analysis time resolution is 1 minute, and therefore, a counted value per se is time.

Further, these values are calculated for each 1 day which is Time Section (FAE17), and an average of Time Period (FAE15) is made to be each value stored.

An explanation has been given of Individual Index (CA1B), an index is not limited thereto. Other index may be created from Meeting Table (FAC) and Body Rhythm Table (FAD), and the other index may be used for an analysis.

Further, although in Individual Index (CA1B), an average in Time Period (FAE15) is stored, a dispersion or the like may also be used.

Further, business information can be stored as Individual Index (CA1B). Individual Index (CA1B) is an index which is calculated from Meeting Table (FAC) and Body Rhythm Table (FAD). Further, FIG. 8 shows Individual Index Table (FAE) as an example of a table of storing an index which is calculated by Individual Index (CA1B). Individual Index (CA1B) is a table of storing an index for each user.

As shown by a lower stage of FIG. 8, Individual Index Table (FAE) can further include organization activity indexes (for example, Work Time Average (FAE9), Office Arrive Time Average (FAE10), Office Leave Time Average (FAE11), Work Time Standard Deviation (FAE12), Office Arrive Time Standard Deviation (FAE13), and Office Leave Time Standard Deviation (FAE14)) in correspondence with a user ID of specifying a user. Although FIG. 8 separately shows an upper stage and a lower stage, FIG. 8 may be configured by one table.

By calculating organization dynamics data acquiring start address and finish address from Meeting Table (FAC) and Body Rhythm Table (FAD), work time, office arrive time, and office leave time are calculated therefrom. Start address signifies an address when organization dynamics data is stored (0 person or more) from when organization dynamics data is not sampled (not mounted, unclear). Further, finish address signifies an address when organization dynamics data is not sampled (not mounted, unclear) from when organization dynamics data is sampled (0 person or more).

Even if time is not stored in Meeting Table (FAC) and Body Rhythm Table (FAD), an individual index is stored therein in a time-sequential order. Therefore, time can be calculated from an acquired address and Time Resolution (FAE16).

With regard to work time, by subtracting a start address from a finish address, time in accordance with a subtracted value becomes work time. Work Time Average (FAE9) is an average of Time Period (FAE15) of work time of each Time Section (FAE17). Work Time Standard Deviation (FAE12) is a standard deviation in Time Period (FAE15) of work time of each Time Section (FAE17).

Office Arrive Time Average (FAE10) is an average in Time Period (FAE15) of time in correspondence with a start address of each Time Section (FAE17). Office Arrive Time Standard Deviation (FAE12) is a standard deviation in Time Period (FAE15) of time in correspondence with a start address of each Time Section (FAE17).

Office Leave Time Average (FAE11) is an average in Time Period (FAE15) of time in correspondence with a finish address of each Time Section (FAE17). Office Leave Time Standard Deviation (FAE14) is a standard deviation in Time Period (FAE15) of time in correspondence with a finish address of each Time Section (FAE17).

It can be determined not to use organization dynamics data in an error state from Meeting Table (FAC) and Body Rhythm Table (FAD).

For example, in a case where a person leaves the office by leaving Nameplate Type Sensor Node (TR), assume that Nameplate Type Sensor Node (TR) reacts with meeting with a nearby node. Although Nameplate Type Sensor Node (TR) does not actually meet the nearby node, the meeting cannot be determined from an infrared ray. In order to increase an accuracy, such an erroneous determination needs to be omitted. As a countermeasure thereagainst, it is determined whether meeting of Meeting Table (FAC) is correct by comparing with Body Rhythm Table (FAD). That is, when there is detected a rhythm (body rhythm is 0 Hz, and for a long period of time) in which a human being is not correctly mounted with Nameplate Type Sensor Node (TR), a value of a meeting table at that occasion is made not to be used. In a consistency processing described above, such a processing may be carried out along therewith.

When an analysis of these is carried out, data is stored to Individual Processing Time Execute Log Table (FAB) as a log. Further, Data Processing Time (FAB6) and Acquiring Rate (FAB9) of data are stored to the table.

Processings of Individual Action (CA1A) and Individual Index (CA1B) described above are carried out for each user. It is determined whether the processings are executed by using a result of Individual Acquiring Rate Confirm (CA1A1) for each user.

In Individual Action (CA1C), an analysis may be carried out by using Individual Index (CA1B) of the user, and other analysis may be carried out. In adding a processing, a new ID is assigned to Processing ID (FAA1) of Individual Processing Reference Table (FAA).

Next, an analysis of an index of an organization is carried out by using a result of an individual. Business Index Analysis (CA1) carries out Organization Acquiring Rate Confirm (CA1C) before a processing in calculating Organization Index (CA1D) in order to make a reduction in an analysis processing amount of data and an increase in an accuracy of contents compatible, confirms an acquiring rate used in analysis at a preceding time and carries out a reprocessing in order to update the index in a case where an acquiring rate is increased.

In a determination of Organization Acquiring Rate Confirm (CA1C1), Organization Processing Reference Table (FAG) of Analysis Result Database (F) is used.

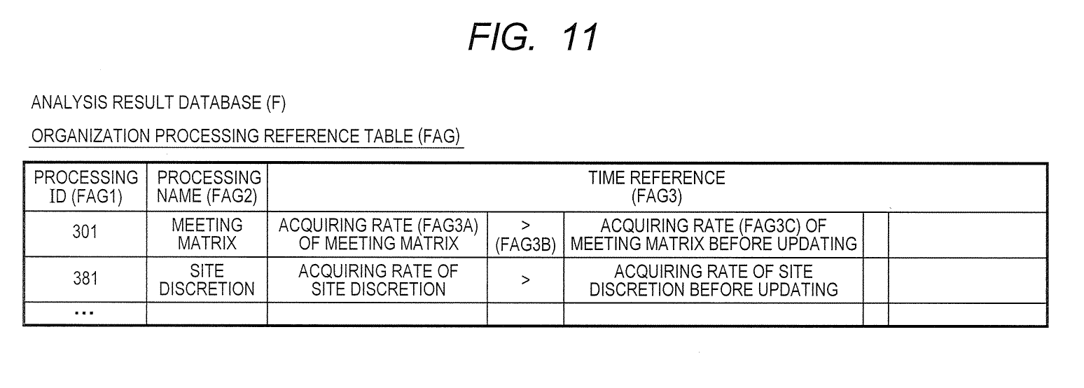

FIG. 11 shows an example of Organization Processing Reference Table (FAG) of Analysis Result Database (F). In Organization Processing Reference Table (FAG), a determination is carried out by an acquiring rate of data. Processing ID (FAG1) is, for example, an identifying number of a processing, and a processing is controlled by ID. Further, a processing program thereof is stored in Analysis Algorithm (D). Processing Name (FAG2) is a name of a processing. Time Reference (FAG3) shows a conditional expression of whether a processing is executed. In a case where the conditional expression is matched by using an equation of an inequality sign or an equality sign described in Time Reference (FAG3), Organization Action Specify (CA1C) is carried out. For example, in FIG. 11, it is described that Acquiring Rate (FAG3A) of Meeting Matrix>(FAG3B), Acquiring Rate (FAG3C) of Meeting Matrix before updating. The equation shows that a processing is executed in a case where an acquiring rate at a current time is larger than an acquiring rate before updating. An acquiring rate before updating (preceding time) is stored in Acquiring Rate (FAH9) of Organization Processing Time Execute Log Table (FAH) in correspondence with a processing ID. Further, in a case where the conditional expression is matched, as described later, Acquiring Rate (FAH9) in correspondence with corresponding processing ID and corresponding mission ID of Organization Processing Time Execute Log Table (FAH) is updated to an acquiring rate which is calculated at current time.

Here, an acquiring rate of a meeting matrix in the drawing is a value in which an acquiring rate of data of each user is calculated on the basis of a meeting table (for example, FIG. 26 subjected to a consistency processing), and an average is calculated with regard to a user related to a mission of a processing object, or an acquiring rate of a user of a minimum acquiring rate or the like. The same goes with also an acquiring rate of site discretion in the drawing. For example, the acquiring rate is a value in which an acquiring rate of a data of each user is calculated with regard to data necessary for processing of site discretion, and an average is calculated with regard to a user related to a mission of a processing object, or an acquiring rate of a user of a minimum acquiring rate or the like.

By arbitrarily changing Reference (FAG3), the conditional expression can be changed.

Further, by providing a threshold (second threshold) in a degree of changing an acquiring rate, in a case where there is a change of a certain constant or more in an acquiring rate, a processing can also be executed. For example, in a case where a change (for example, an increase) in an acquiring rate is equal to or more than 5 points, a processing is executed or the like.

Further, an upper limit (first threshold) may previously be determined, and even when the acquiring rate is equal to or more than the upper limit, a processing can be made not to execute. For example, when an acquiring rate is equal to or more than 98%, even if an acquiring rate is equal to or more than 98%, a processing is made not to execute again. At this occasion, an analysis server determines an analyzed state.

Further, a determination under plural references can be carried out, and an analysis of only a corresponding processing ID can be executed from a result of the determination. Further, a determination under plural references can be executed, and even when only one of conditional expressions is matched, a processing can be executed for all of processing ID's.

In a case where it is determined that a processing of Organization Action (CA1C) is needed by Organization Acquiring Rate Confirm (CA1C1), Organization Action Specify (CA1C2) of Organization Action (CA1C) is carried out. In that case, a log of a result of a processing which is carried out by Organization Action Specify (CA1C2) is described in Organization Processing Time Execute Log Table (FAH).

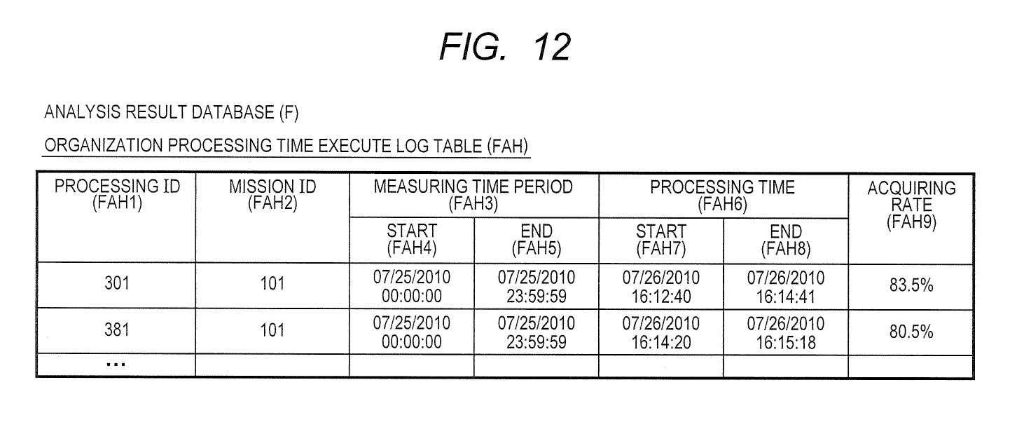

FIG. 12 shows an example of Organization Processing Time Execute Log Table (FAH) of Analysis Result Database (F). This is a table of describing a log of a result of an execution by Organization Action Specify (CA1C2) by a determination by using Organization Processing Reference Table (FAG). Processing ID (FAH1) is, for example, an identification number of a processing, and a processing is controlled by ID. Further, a processing program thereof is stored in Analysis Algorithm (D). Mission ID (FAH2) is ID for identifying a mission. Measuring Time Period (FAH3) describes a time period of measuring sensor data (for example, a measuring time period of sensor data which becomes an object of a processing). Start (FAH7) is measuring start time. End (FAH5) is measuring finish time. Processing Time (FAH6) describes time of processing. Start (FAH7) is processing start time. End (FAH8) is processing finish time. Acquiring Rate (FAH9) shows a degree of acquiring sensor data. An acquiring rate in this case is obtained from Acquiring Rate (FAB9) of Individual Processing Time Execute Log Table (FAB) in a corresponding time period or a corresponding user.

Acquiring Rate (FAB9) of Individual Processing Time Execute Log Table (FAB) is an acquiring rate for each individual (individual acquiring rate), an average in a member who is related to a mission indicated by mission ID (organization acquiring rate) is calculated, and the average is stored to Acquiring Rate (FAH9) of Organization Processing Time Execute Log Table (FAH). Further, Acquiring Rate (FAB9) is an acquiring rate for each measuring time period, and in a case where a section used for a processing includes plural measuring time periods, an average value thereof is stored as Acquiring Rate (FAH9).

In a processing of Organization Action Specify (CA1C2), a corresponding user of Project Table (FAF) is selected, and an analysis is carried out by using a result of a processing of Individual Action (CA1A) or Individual Index (CA1B) of the user. An explanation will be given of a processing of Meeting Matrix Create (CA1C2A) of Organization Action Specify (CA1C2).

Meeting Matrix Create (CA1C2A) summarizes how meeting is carried out for each user by removing time-sequential information from Meeting Table (FAC) arranged time-sequentially into a two-dimensional matrix.

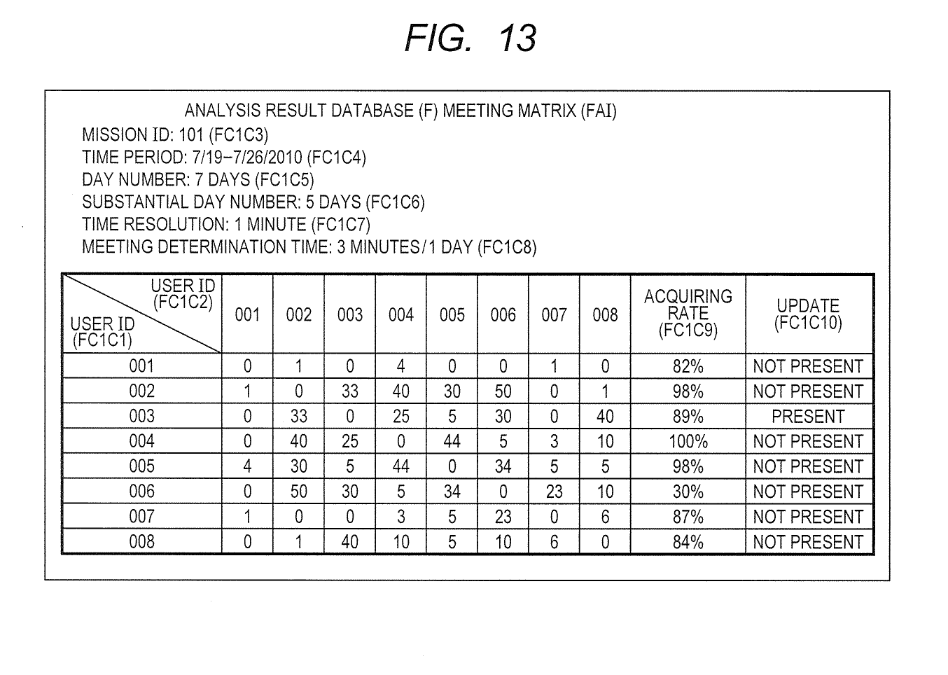

An extracted result is stored in Meeting Matrix (FAI) of Analyzing Result Database (F). FIG. 13 shows an example of Meeting Matrix (FAI). FIG. 13 summarizes a result of meeting in a time period indicated by Time Period (FC1C4). Further, a unit is made by time resolution in Meeting Matrix (FAI). Therefore, in a case where 1 is stored in Meeting Matrix (FAC) meeting is carried out for 1 minute when time resolution is 1 minute, and 5 minutes when time resolution is 5 minutes.

In Meeting Matrix (FAI), the ordinate is User ID (FC1C1) for determining an individual member, and the abscissa is User ID (FC1C2) showing a meeting counterpart. For example, meeting time of user 002 with user 003 becomes 33 minutes.

In creating Meeting Matrix (FAI), a number of pieces of information are summarized in one matrix. Therefore, original information can also be described.

Mission ID: 101 (FC1C3) is mission ID using the data.

Time Period: Jul. 19-Jul. 26, 2010 (FC1C4) shows a time period of data used in creating Meeting Matrix (FAI).

Day Number: 7 days (FC1C5) is a day number in Time Period (FC1C4).

Substantial Day Number: 5 days (FC1C6) is a day number of a business in Time Period (FC1C4).

Time Resolution: 1 minute (FC1C7) is a time resolution in Meeting Table (FAC).

Meeting Determination Time: 3 Minutes/1 Day (FC1C8) is a threshold for determining meeting. When an infrared ray is reacted even in a case where persons pass by, a determination of meeting is carried out. Therefore, there is a high possibility that several times of reactions are noises. Therefore, such a threshold is introduced.

Further, Acquiring Rate (FC1C9) is an acquiring rate of data and is a rate of effective data which is calculated from Meeting Table (FAC) or Body Rhythm Table (FAD) and which removes a portion of unclear data. Further, Update (FC1C10) describes “present” in a case of updating data for each user.

Further, contents can preferably image a reliability for a user, and a number of days of data used, time of data used or the like may be included.

Further, it is important for Meeting Matrix (FAI) to store a meeting situation of a user. Therefore, so far as this is satisfied, a table configuration may differ from that used in Meeting Matrix (FAI).

In Organization Action (CA1C), a corresponding user of Project Table (FAF) is selected, an analysis may be carried out by using a processing result of Individual Action (CA1A) or Individual Index (CA1B) of the user, and a pertinent analysis other than Analysis Result Meeting Matrix Create (CA1C2A) may be carried out. In a case of addition, new ID is assigned to Processing ID (FAG1) of Organization Processing Reference Table (FAG).

Next, Organization index (CA1D) is calculated. In a processing of Organization Index (CA1D), an analysis is carried out on the basis of a result of an analysis by Organization Action (CA1C) or Individual Action (CA1A), or Individual Index (CA1B). At that occasion, a log of a result of a processing which is carried out by Organization Action (CA1C) is described in Organization Processing Execute Log Table (FAR).

In a processing of Organization Index (CA1D), there are calculated respective indexes of Site Discretion (CA1DA) and Top/Down Cooperation (CA1DB) and Bidirectional Conversation (CA1DC). A result thereof is stored to Organization Index Table (FAJ).

Site Discretion (CA1DA) is an index indicating a degree of discretion of business at site. As an example thereof, there is a degree of unity, which can be calculated by Meeting Matrix (FAI) created by Meeting Matrix Create (CA1C2A).

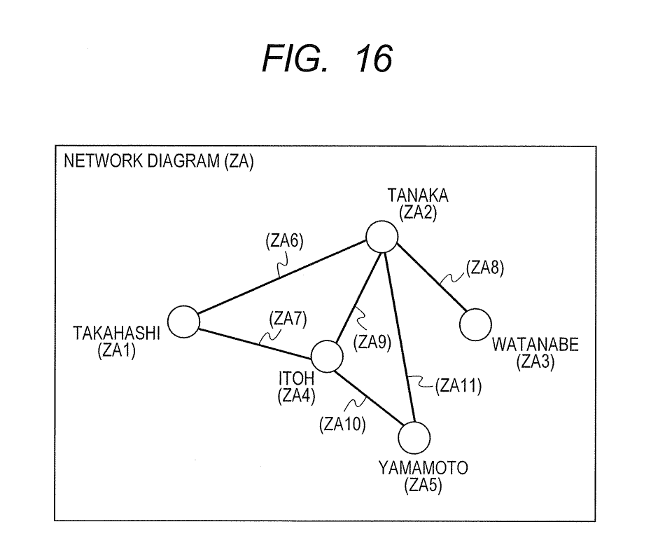

An explanation will be given of a method of calculating an index of site discretion in reference to Network Diagram (ZA) of FIG. 16. FIG. 16 shows a person by a node and shows meeting between 2 persons by line (edge). In determining line, line is connected for a case where meeting time between 2 persons is a certain constant or more from Meeting Matrix (FAI).

A unity degree is a density of nodes around one's own surrounding. In an example of Network Diagram (ZA) of FIG. 16, meeting counterparts of Itoh (ZA4) are 3 persons of Takahashi (ZA1), Yamamoto (ZA5), and Tanaka (ZA2). A density of 3 persons may be investigated. As a result thereof, edge number in 3 persons/maximum edge number in 3 persons=2/3=0.67.

An index of discretion may previously be calculated for each user, and an average value in members of a project may be made to be Site Discretion (CA1DA).

Further, not a degree of unity but degree, 2 steps reaching degree, intermediary center performance may be used as Site Discretion (CA1DA).

As a way of calculating these, a degree is a number of edges connected to a node. In an example of Network Diagram (ZA), Takahashi (ZA1) is connected to Tanaka (ZA2) and Itoh (ZA4), and therefore, a degree is 2.

2 steps reaching degree is a number of nodes which are present in a range within 2 steps as a whole. In the example of Network Diagram (ZA), a total of nodes which can be covered by 2 steps in a case of Watanabe (ZA3) are (ZA1) through (ZA5), and the 2 steps reaching degree becomes 4.

An intermediary center performance is a value representing to what degree a node is contributed to a connecting performance of a total of the network diagram.

Next, an explanation will be given of an index of indicating a cooperation degree from a leading member to a member in Top/Down Cooperation (CA1DB). As an example, there is step number, and the step number can be calculated by Meeting Matrix (FAI) created by Meeting Matrix Create (CA1C2A).

As a way of calculating, Project Table (FAF) and User ID Table (IA) are tested by comparison, a leading member is specified, and it is calculated by what shortest steps a member is connected to other member. In an example of Network Diagram (ZA), Takahashi (ZA1) and Itoh (ZA4) are connected by 1 step. Takahashi (ZA1) and Watanabe (ZA3) are connected by 2 steps.

A step number may previously be calculated for each user, and an average value among members of a project may be made to be Top/Down Cooperation (CA1DB). Further, a leading member may be Leader (FAF2) and Requester (FAF3) indicated by Project Table (FAF).

Bidirectional Conversation (CA1DC) is an index indicating a degree of bidirectional behavior in meeting of members. As an example thereof, a determination can be made by looking at a physical rhythm in meeting.

At certain time, a meeting counterpart is selected from Meeting Table (FAC), and a physical rhythm at the same time is selected from Body Rhythm Tables (FAD) of the meeting counterpart and a member per se. Further, when selected respective body rhythms (indicating a behavior of a member per se and a behavior of a counterpart) are equal to or more than a previously determined threshold, a bidirectional conversation is determined. Bidirectional rates may be calculated for respective members, and an average value thereof among members of a project may be made to be Bidirectional Conversation (CA1DC).

The index is not limited thereto, but other index may be created from Meeting Matrix (FC1C), and the other index may be used for analysis.

In a processing of Organization Index (CA1D), an analysis may be made by using a result of processings of Organization Action (CA1C), Individual Action (CA1A), and Individual Index (CA1B), and an analysis other than Site Discretion (CA1DA) and Top/Down Cooperation (CA1DB) and Bidirectional Conversation (CA1DC) may be carried out. In a case of addition, new ID is assigned to Processing ID (FAG1) of Organization Processing Reference Table (FAG).

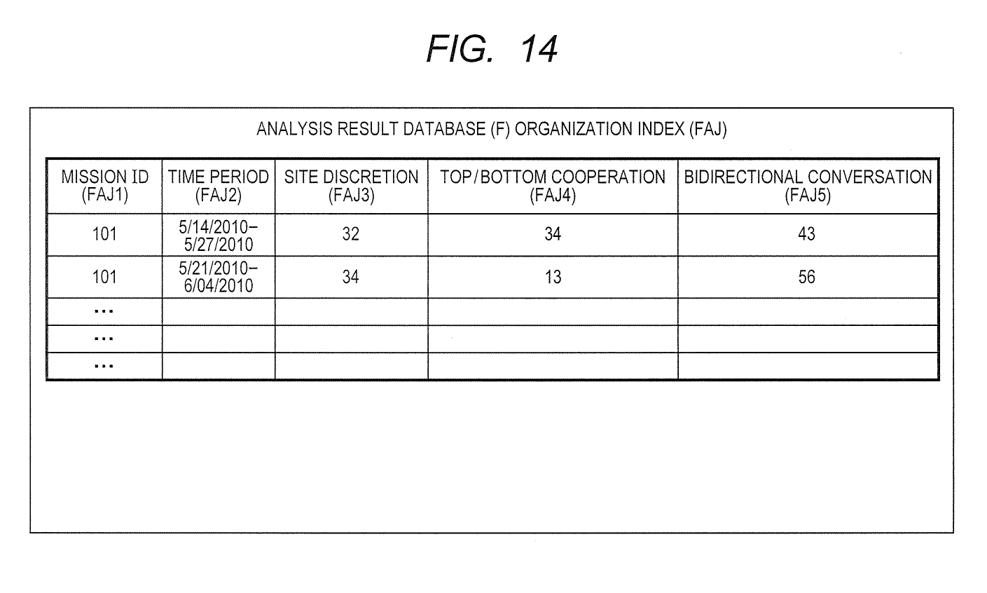

FIG. 14 shows an example of Organization Index (FAJ) of Analysis Result Database (F). Organization Index (FAJ) stores respective indexes of Site Discretion (CA1DA) and Top/Bottom Cooperation (CA1DB) and Bidirectional Conversation (CA1DC) which are calculated by Organization Index (CA1D).

Mission ID (FAJ1) identifies a project. Mission ID (FAJ1) corresponds to Mission ID (FAF1) of Project Table (FAF). Time Period (FAJ2) indicates a time period of data used in the analysis. Site Discretion (FAJ3) is an index of Site Discretion (CA1D) of Organization Index (CA1D). Top/Bottom Cooperation (FAJ4) is an index of Top/Bottom Cooperation (CA1DB) of Organization Index (CA1D). Bidirectional Conversation (FAJ5) is an index of Bidirectional Conversation (CA1DC) of Organization Index (CA1D).

As a processing described above, Organization Action (CA1C) or Organization Index (CA1D) is carried out for each mission of Mission ID (FAF1) of Project Table (FAF). It is determined whether the processing is executed by using a result of Organization Acquiring Rate Confirm (CA1C1) for each mission.

Next, an explanation will be given of Project Progress Contents Create (JA) which is a portion of actually creating contents. Project Progress Contents Create (JA) includes two processings of Network Diagram Create (JAA) and Line Graph Create (JAB).

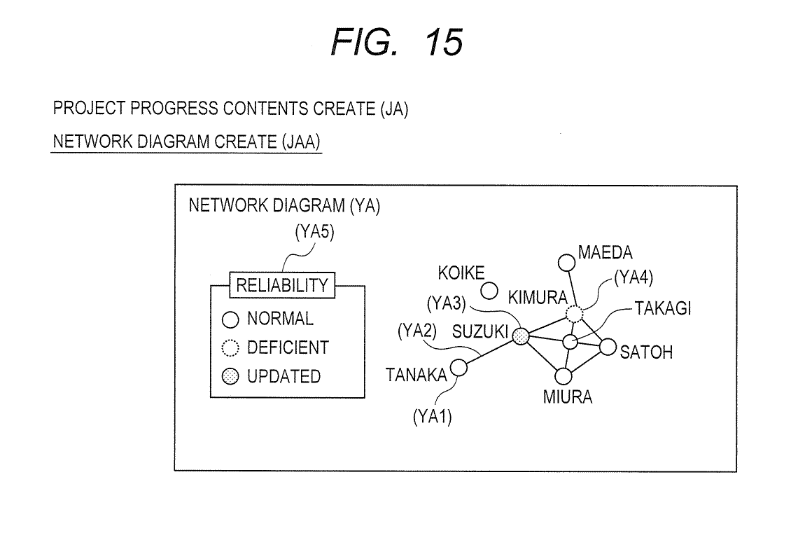

First, an explanation will be given of Network Diagram Create (JAA). Network Diagram (YA) of FIG. 15 is an example of a network diagram. Network Diagram (YA) is created on the basis of Meeting Matrix (FAI), and is configured by, for example, Node a First, representing a person, and Line (Edge) (YA2) connecting meeting members. In an arrangement, a spring model is used. Spring Model (Hooke's Law) is a method in which in a case where two nodes (points) are connected, a force (in an inward direction or in an outward direction) is calculated by assuming that there is a spring therebetween, and an optimum arrangement is made by repeating a movement of a position by assuming that a repulsive force (repulsing force) is received in accordance with a distance from all of nodes which are not connected to the node of its own.

Further, for example, Reliability (YA5) is shown by, for example, a shape of a node. The reliability is described such that “deficient” in which a data acquiring rate is smaller than a previously determined threshold or “updated” of presence or absence of updating data is known by utilizing data of Acquiring Rate (FC1C9) or Update (FC1C10) of Meeting Matrix (FAI). (YA1) indicates normal (bold line white circle in the drawing), (YA4) indicates deficient (dotted line white circle in the drawing), and (YA3) indicates updated (hatched circle in the drawing). Further, other than a shape of a node, a display mode may pertinently differ such as color, line kind, pattern or the like.

Further, contents of reliability may preferably be able to be imaged by a user, and number of days of data used, time of data used or the like may be included.

Next, an explanation will be given of Line Graph Create (JAB). In Line Graph Create (JAB), a line graph is created by arranging data of Organization Index Table (FAJ) which is Organization Index (CA1D) in a time-sequential order.

A result of creating by project Progress Contents Create (JA) is Project Progress Contents (KA).

Contents created by project Progress Contents Create (JA) is described with a reliability by an amount of data used in creating contents. An example of indicating a reliability there is an acquiring rate of data. According to the present embodiment, an acquiring rate of data is calculated from unclear data by Meeting Table (FAC) or Body Rhythm Table (FAD) of Analysis Result Database (F). So far as a reliability can be indicated from data, other method may be used.

Project Progress Contents can be updated by executing respective processings of FIG. 2D in a case where an acquiring rate of data is increased.

Here, an explanation will be given of Enterprise Information Analysis (CA2) of Business Action Analysis (CA). It is an object of the processing to make a cooperation with other enterprise information and supplement data to each other.

Enterprise Information Summarizing Server (KS) is a server which makes a hub of other Enterprise Information System, which makes a cooperation with various servers starting from Traveling Expense Server (RS1) as shown by FIG. 1C, and summarizes information in Enterprise Information Summarizing Database (KSME1) of Enterprise Information Summarizing Server (KS).

In Enterprise Information Analysis (CA2) at Application Server (AS), by making a cooperation with Enterprise Information Summarizing Database (KSME1) of Enterprise Information Summarizing Server (KS), data which is not obtained by Analysis Result Database (F) or Organization Information Database (H) is supplemented, and there is provided enterprise information which is present in Analysis Result Database (F) or Organization Information Database (H) and which is not present in Enterprise Information Summarizing Database (KSME1).

In Supplementary Input (CA2A), information in Enterprise Information Summarizing Server (KS) is obtained. This is information of Individual Business Action Master Table (KSME1A) or Organization/Project Business Action Master Table (KSME1B) of Enterprise Information Summarizing Database (KSME1).

In Supplementary Extraction (CA2B), there is extracted a portion which can be supplemented by checking with contents which are present in Analysis Result Database (F) or Organization Information Database (H).

In checking, there is needed ID for checking corresponding both, and in that case, there may be used ID for checking the both by using User ID (IA1) of User/Location Information Database (I) or Mission ID (FAF1) of Project Table (FAF).

In Supplementary Output (CA2C), there is carried out a processing of writing contents extracted by Supplementary Extraction (CA2B) actually to Analysis Result Database (F) or Organization Information Database (H). In carrying out the processing, owing to supplementation, an acquiring rate is calculated, and a result thereof is written to Individual Processing Time Execute Log Table (FAB) or Organization Processing Time Execute Log Table (FAH).

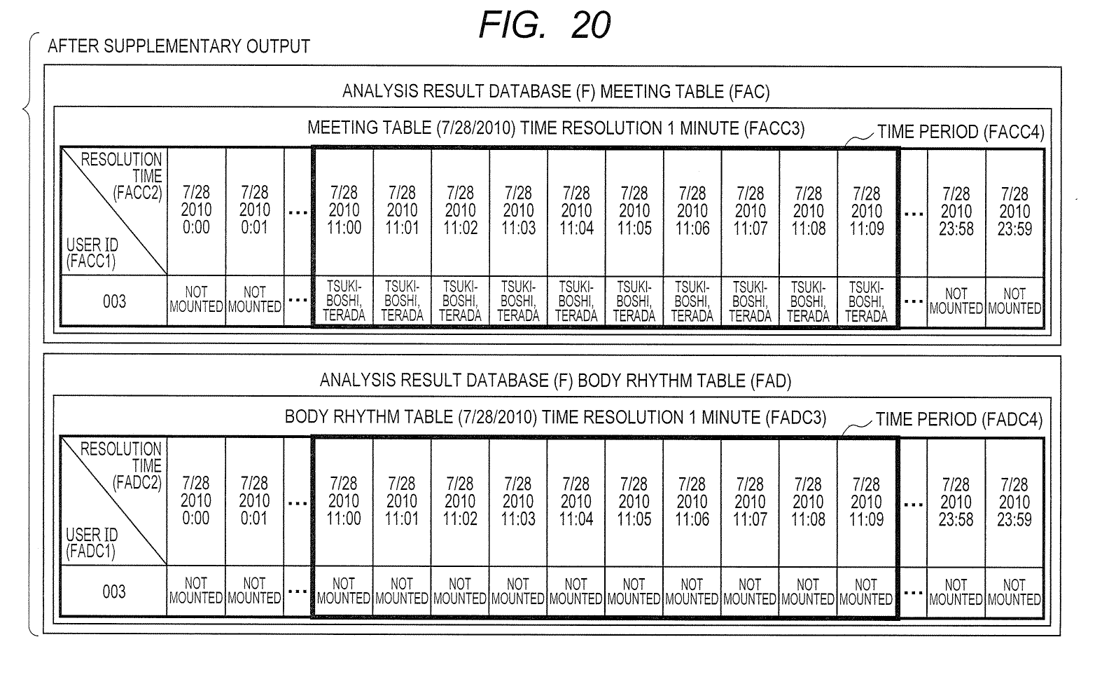

FIG. 20 shows an example of Meeting Table (FAC) and Body Rhythm Table (FAD) of Analysis Result Database (F) after Supplementary Output (CA2C).

Meeting Table (FAC) and Body Rhythm Table (FAD) are reflected with a result of Individual Business Action Master Table (KSME1A) or Organization/Project Business Action Master Table (KSME1B) of Enterprise Information Summarizing Database (KSME1).

In Individual Business Action Master Table (KSME1A), it is described that an arrangement with Mr. Terada of Tsukiboshi Shoji is carried out from Company/Section (KSME1AE) and Meeting Counterpart (KSME1AG) until 11:00-11:30 of user 003. Therefore, Tsukiboshi, Terada is stored in Time Period (FACC4) of Meeting Table (FAC). Further, in Time Period (FADC4) of Body Rhythm Table (FAD), it is not known what action is carried out. Therefore, “not mounted” is described. These data are reflected to Analysis Result Database (F) as in FIG. 20.

Further, when a company or a meeting counterpart is not known, there may be used Area/Station (KSME1AD) which is information other than Company/Section (KSME1AE) and Meeting Counterpart (KSME1AG). Further, in a case where a person cannot be specified, there may be used only Company/Section (KSME1AE).

The example shown in the above-described is an example, and a result of Enterprise Information Summarizing Database (KSME1) may be reflected to Analysis Result Database (F) or Organization Information Database (H).

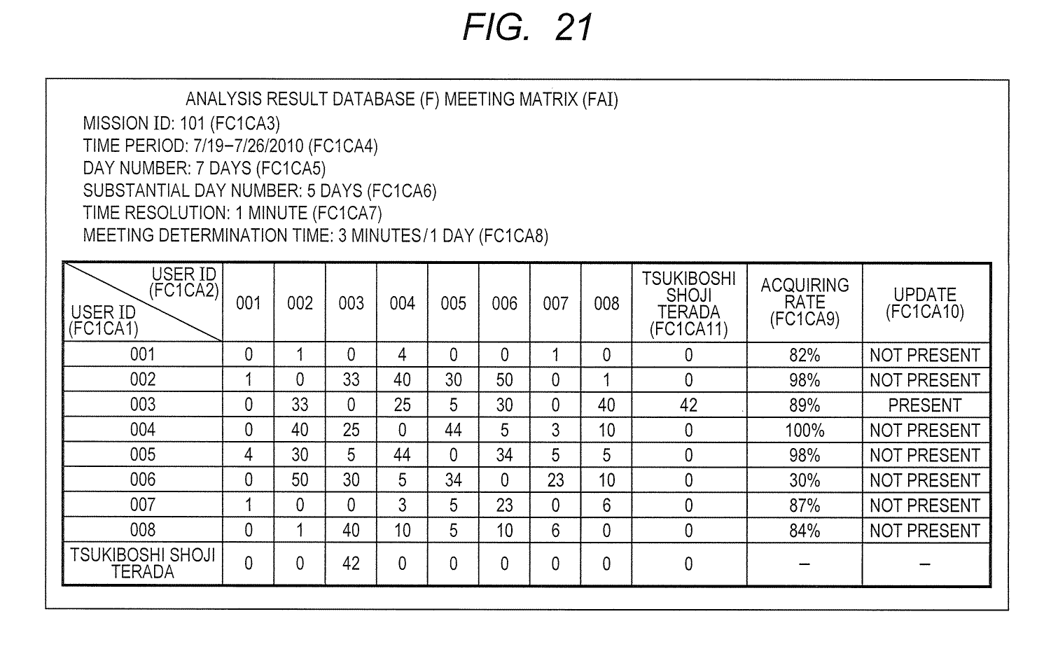

Next, a description will be given of an example of creating Meeting Matrix Create (CA1C2A) by using Supplement Output (CA2C). FIG. 21 is a meeting matrix which combines an arrangement with outside of company to Meeting Matrix (FAT) shown in FIG. 13. A point of addition to FIG. 13 is adding a person outside of company as a user, and adding Tsukboshi Shoji Terada (FC1CA11) in FIG. 21. In this way, a user inside or outside of a company department can be dealt with in one meeting matrix.

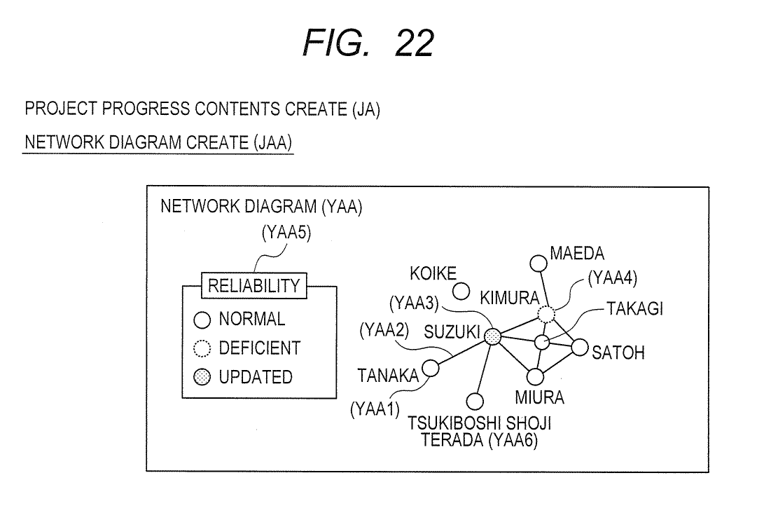

Next, FIG. 22 shows an example of Network Diagram Create (JAA) from Meeting Matrix (FAI) of FIG. 21. This is the same as a creating method of Network Diagram Create (JAA) of FIG. 15. In FIG. 22, there is used Meeting Matrix (FAI) of FIG. 21 including meeting data at inside and outside of a company department. Therefore, data of other department (Tsukiboshi Shoji Terada (YAA6)) is displayed.

Further, the method shown in the above-described is one example, and member cooperation with inside and outside of a company may be known.

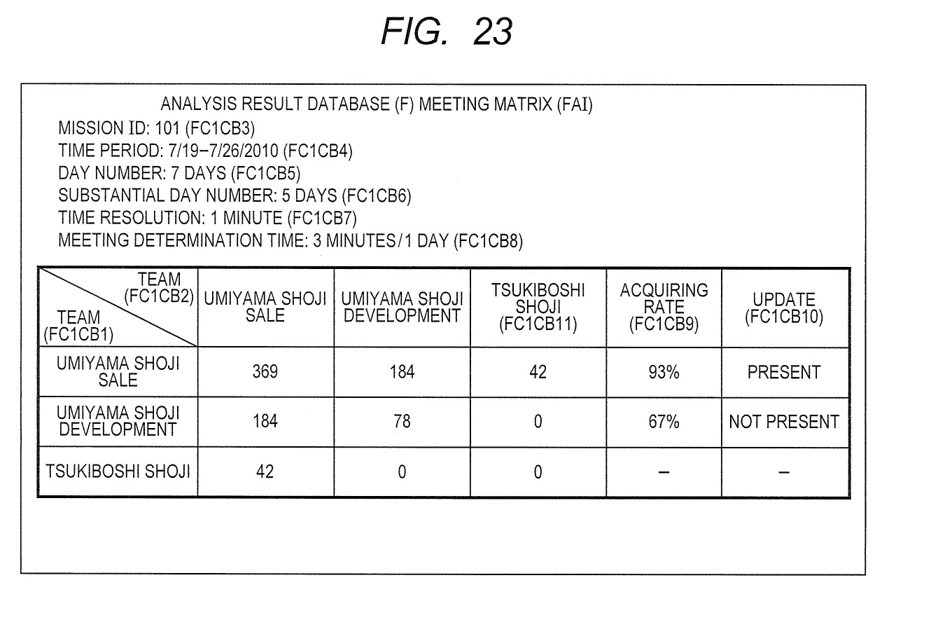

Further, although a network diagram is created on the basis of an individual user, plural persons may be summarized to one. As an example thereof, FIG. 23 shows Meeting Matrix (FAI) clustering by Team Name (IA3) of User/Location Information Database (I), and summarizing data with outside of a department. A clustering method of Meeting Matrix (FAI) of FIG. 21 through FIG. 23 is preferably a method by which cooperation with inside and outside of a team is known. As an example thereof, FIG. 23 calculates sums respectively from inside and outside of a team from a table of FIG. 21.

Further, Acquiring Rate (FC1CB9) displays an average of a team, and Update (FC1CB10) displays that update is present in a case where there is an updated member in a team.

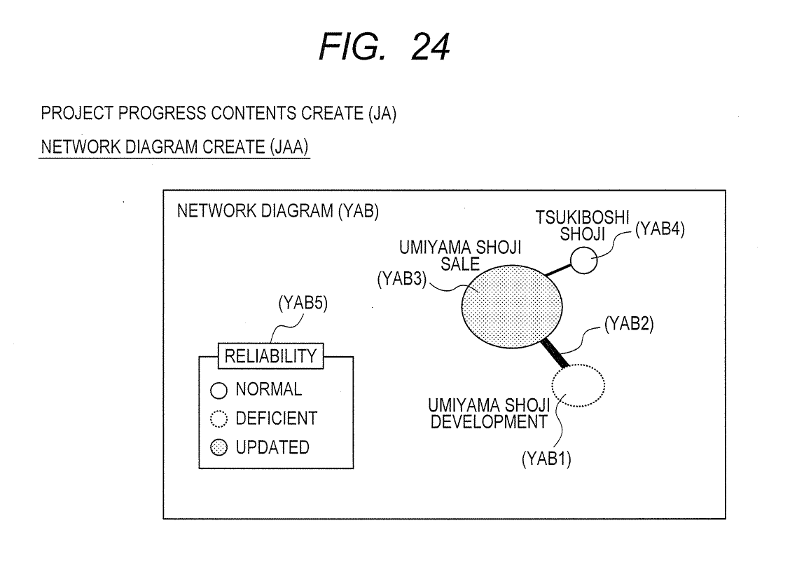

Next, FIG. 24 shows an example in which there is carried out Network Diagram Create (JAA) from Meeting Matrix (FAI) of FIG. 23. Basically, a method thereof is the same as a creating method of Network Diagram Create (JAA) of FIG. 15. A point of difference resides in displaying meeting time in a team by a size of a node, and displaying meeting time with outside of a team by a boldness of an edge (line).

Further, the method shown in the above-described is an example, and there may be known cooperation between teams of inside and outside of a company.

Further, in the present processing, data collected by Organization Dynamics Data Collect (B) can be used, and a similar analysis may be carried out for Sound Sensor (BAF), Temperature Sensor (BAG), Illumination Sensor (BAH), Notice (BAI), Acknowledgement (BAJ), and Net Ability (BAK) included in Data Table (BA) of Organization Dynamics Data Collect (B).

By carrying out such a processing, there are created project progress contents in consideration that a reduction in a processing amount of analyzing data and an increase in an accuracy of contents are compatible with each other.

The present invention can be used in, for example, a system of carrying out a batch processing on the basis of sensor data.

What is claimed is:

1. A sensor information analysis system comprising:
a plurality of sensor nodes of transmitting a data subjected to sensing; and
an analysis server of carrying out a predetermined batch processing by using the data from the plurality of sensor nodes;
wherein a desired number of the data transmitted from the sensor node within a previously determined time period is previously determined;
wherein the analysis server calculates a data acquiring rate on the basis of the desired number of the data, and a number of the data within the previously determined time period received actually from the plurality of sensor nodes with regard to the data used in the predetermined batch processing; and
wherein in a case where there is a variation in the data acquiring rate, the batch processing is carried out.

2. The sensor information analysis system according to claim 1,
wherein the sensor node transmits a data indicating that the sensing is not carried out even when the sensing is not carried out, and transmits a real data subjected to the sensing when the sensing is carried out; and
wherein the analysis server determines an effective data by both of the data indicating that the sensing is not carried out and the real data, and calculates the data acquiring rate by determining a deficient data as an unclear data.

3. The sensor information analysis system according to claim 1, wherein the analysis server carries out the batch processing when the variation in the acquiring rate exceeds a previously determined first threshold.

4. The sensor information analysis system according to claim 1, wherein when the data acquiring rate exceeds a previously determined second threshold, the analysis server determines an analyzed state even when the data acquiring rate is not 100%.

5. The sensor information analysis system according to claim 1, wherein the batch processing is a processing for obtaining a display data on the basis of the data subjected to the sensing.

6. The information system according to claim 5, wherein the analysis server changes a display mode of a result of the batch processing in accordance with the data acquiring rate.

7. The sensor information analysis system according to claim 1, wherein the data acquiring rate is an acquiring rate with regard to the data subjected to the sensing from one of the sensor nodes, and the analysis server carries out the batch processing with regard to the sensor node.

8. The sensor information analysis system according to claim 1,
wherein the data acquiring rate is an acquiring rate with regard to the data subjected to the sensing from the plurality of sensor nodes related to the predetermined batch processing; and
wherein in the case where there is the variation in the acquiring rate, the predetermined batch processing is carried out on the basis of the data subjected to the sensing from the plurality of sensor nodes.

9. The sensor information analysis system according to claim 2,
wherein the sensor node includes a plurality of sensors, and transmits a plurality of the data subjected to the sensing to the analysis server in correspondence with a time point at which the sensing is carried out; and
wherein when the analysis server detects the deficient data with regard to a data at a certain time point, the analysis server determines the unclear data also with regard to a data of other sensor at the time point, and calculates the data acquiring rate.

10. The sensor information analysis system according to claim 1, further comprising:
an information summarizing database previously stored with a piece of action information of a user who is mounted with the sensor node;
wherein the analysis server changes or supplements the data subjected to sensing on the basis of the piece of action information stored to the information summarizing database, and calculates the acquiring rate with regard to the supplemented data.

11. An analysis server which carries out a predetermined batch processing by using a data from a plurality of sensor nodes of transmitting the data subjected to sensing, and in which a desired number of the data transmitted from the sensor node within a previously determined time period is previously determined;
wherein the analysis server calculates a data acquiring rate on the basis of the desired number of the data and a number of the data within the previously determined time period received actually from the plurality of sensor nodes with regard to the data used in the predetermined batch processing; and
wherein in a case where there is a variation in the data acquiring rate, the analysis server carries out the batch processing.
